(19) United States
(12) Patent Application Publication
(10) Pub. No.: US 2005/0165881 A1
(43) Pub. Date: Jul. 28, 2005

(54) Event-driven queuing system and method

(75) Inventors: Troy B. Brooks, Port Moody (CA); Anthony Higa, Honolulu, HI (US); Shinya Yarimizo, Kailua, HI (US); Chih-Chieh Yang, Honolulu, HI (US)

Correspondence Address: Paradise Patent Services, Inc.;Attn: George Darby, P.O. Box 893010, Mililani, HI, 96789-3010, US

(73) Assignee: PipelineFX, L.L.C.

(21) Appl. No.: 10/764,028

(22) Filed: Jan. 23, 2004

(51) Int. Cl. G06F 15/16

(52) U.S. Cl. 709/200

(57) ABSTRACT

The event-driven queuing system and method (“EDQS”) comprises at least one each of a client, supervisor, and worker, together with network communications between each client and supervisor and between each supervisor and worker, and a component selected from the group comprising EDQS messaging architecture, EDQS job routing, EDQS event/callback architecture, EDQS job type data architecture, and the EDQS domain specific language. The EDQS typically provides arithmetical increases in dispatch time as jobs and workers are added to a farm, substantial improvements in processing jobs based on the status of one or more other jobs in a process group, and substantial improvements in the use of standalone or clustered heterogeneous platforms in a farm.

### BACKGROUND OF THE INVENTION

1. Technical Field

A “queuing system” is software that allocates the processing of jobs among networked computers, issues commands to such networked computers, and tracks the jobs through completion; many queuing systems generate status and/or error reports as part of job tracking. The detailed nature of “processing a job” varies by industry, but is generally a computational task that often consumes computing resources for an extended period (minutes to hours, or even days). Queuing systems exchange messages with users and with processes running on resources, such as computers, storage devices, networks, network devices, and associated software (collectively, “resources”). A “host” is a computer connected to a network and capable of running application software. The population of hosts connected to a common network and available to perform processing is called a “farm”. A “platform” is a computer with a given combination of operating system, central processing unit (“CPU”), and related hardware specific to such CPU.

Keeping track of submitted, executing, and completed jobs requires, among other things: sophistication in message-passing; communication synchronization; granularity of commands, monitoring, and reporting; a management daemon; and worker daemons. “Granularity” is the degree to which a job can be divided into distinct tasks or components, the degree to which a queuing system can manage such tasks or components, and the degree to which resources are finitely distributed over a network. The “management daemon” (called a “supervisory daemon” in the invention) in a queuing system is the executive component, as distinct from services that are provided by resources in response to commands of the executive. A “worker daemon” is a process running on a resource that causes jobs to be processed on a worker in response to messages from a management daemon. “Job allocation and management”, one approach to which is called “load sharing” or “fair share”, is a primary function of a management daemon. A “process” is an executing software program, which may be part of a larger software program or software architecture. A “domain” is a definition of the functions, objects, data, requirements, relationships and variations in a particular subject area or business. “O(n)” means a mathematical function that approximates overall performance. “T(n)” means a mathematical function that approximates temporal performance.

Job allocation and management is characterized by many conflicting demands. For instance, an allocation method of “process shortest job first” will minimize average runtime (the elapsed time between job submission and completion), but the domain addressed by queuing systems usually includes jobs whose duration is not known in advance, or whose demands for resources may vary, or for which certain necessary resources may be unavailable at the time of job submission. Therefore, allocating jobs on a “shortest job first” criterion typically produces sub-optimal and even unpredictable results. A second example of conflicting demands is job priority. An “arbitrary” priority, such as one assigned by a user and unrelated to any historical data or resource requirements, can conflict with “load-balancing”, or “fair-share”, priority assignment methods. Both user and load-balancing priorities may be overridden by having to rerun a job that has a financial penalty if the relevant deadline is missed.

2. Description of the Related Art

The existing art of queuing systems is characterized by job allocation and management based on fixed and/or a limited set of job allocation rules. Such systems are easier to design and code, but consume inordinate amounts of time and resources as the number of jobs and/or hosts increase(s). The optimal queuing system is one that accommodates different types of jobs and different granularity, that can immediately match jobs and resources, and in which runtime scales linearly rather exponentially as jobs and hosts are added to a farm. Existing queuing systems typically maintain a master job queue and continuously sort jobs versus hosts, which consumes significant computing power. As a rough approximation (assuming jobs and hosts have already been sorted), if the number of jobs is m, and the number of hosts in a farm is n, the calculations required to compute a job queue is T(m,n)=m*n. Normally, there are more jobs than hosts, so in a best case, m=n. As a job or host is added, the order of calculation complexity required to compute a job queue is T(n.sup.2), an exponential growth. The traditional approach to computing a job queue quickly becomes a processor-bound bottleneck that compromises the productivity of the entire farm.

Increasing the granularity of management and reporting, and the dynamic matching of jobs and resources, requires solving formidable problems related to job and resource analysis, and continually updating the supervisory daemon. Few, if any, queuing systems in use today have solved these problems. Increased network data rates mean that a queuing system can theoretically obtain and manage otherwise idle time on any and all computers on a network, especially idle time on personal workstations when human users are not logged in. Networked computing resources are increasingly numerous and distributed, and resource availability changes as human users log on and off their personal computers. One approach to the problem of distributing computational resources is to link by network or bus a group of computers to form an inexpensive parallel-processing system called a “compute cluster,” but such a cluster needs a distributed memory architecture tailored to cluster computing. Even if an operating system supports such clustering, the clustering support is often proprietary to a single manufacturer's line of computers. Therefore, queuing systems are increasingly directed to different types of networked computers, and must accommodate the lack of a uniform operating system environment. Interconnection of computers in a non-proprietary networked cluster is usually by LAN and/or wide area network (“WAN”), and the computers so networked typically use different CPUs and operating systems (“heterogeneous platforms”). In addition to heterogeneous platforms, queuing system designers must also accommodate network congestion, notifications, conditional actions, variations in types of software and resources, and conflicting priorities.

Clusters of heterogeneous platforms are already common in many industries, such as: semiconductor device design; printed circuit board design; computer graphics; proteomic, genomic, and other biotech modeling; automotive engineering; and other types of engineering. Computer-generated theatrical films are one of the most challenging domains for queuing systems, since each frame of computer graphics requires a few minutes to a few days of “rendering” (generating 3D graphics and lighting from textual instructions), depending upon complexity of the graphics and processing power of the computer; each second of film contains 24 frames. Other industries are adopting the use of heterogeneous platforms, including clusters of heterogeneous platforms. The domain model of heterogeneous platforms involves a network architecture of (1) application servers that use executables to process various data, e.g., to process data stored in one or more file formats (which files are collectively called, “source files”) into a second file format, such as graphics, maskworks, etc. (which files are collectively called, “output files”), (2) data servers that store and serve the source files, asset files, and output files, (3) one or more administrative servers on which management daemons run, and (4) other servers, such as Web servers that provide a graphical user interface between users and the resources. For example, in the domain of computer graphics rendering, the application servers render scene specification data files into “computer graphic image” (aka “CGI”) output files.

Existing queuing systems, especially those published for heterogeneous platforms, typically rely on (1) a human (an end-user and/or a “system administrator”) to assign priorities to jobs, with the obvious problem that each user often considers his or her job to have high priority, and (2) load-sharing software that periodically balances the workload among clusters and among computers within clusters based on a limited set of performance rules, an approach that does not allow system administrators to predict where or when a job will execute; and (3) generalizing all possible permutations of known user, administrator, and system requests and coding of those permutations into the supervisory daemon, which results, inter alia, in an intractably large search tree. The existing art methods of balancing job priority is to adjust user-assigned priority values of jobs in a queuing system that uses a user-assigned priority system, or to adjust the weights on queues in a queuing system that uses a fair share weighting system. The first method is tedious, and error prone, and the second method is unpredictable and doesn't show results quickly enough. Existing queuing systems have difficulty identifying processing bottlenecks and handling resource failures, handling the unexpected introduction of higher priority jobs, and increasing the number of jobs and hosts. Moreover, existing queuing systems developed and marketed for a particular industry or application, e.g., semiconductor device design or automotive engineering, are often ill-suited for other uses. Existing art queuing systems use a management daemon that executes a single-threaded program or script, or one that is at least single-threaded for the “sort and dispatch” process.

To understand the improvements in queuing system performance provided by the EDQS invention, an overview of how queuing system performance is analyzed is helpful. Queuing system performance (“T(n)”) is approximated by the “sort and dispatch” equation, T(n,m)=(n*m)+(n log n)+(m log m), where “n” is the number of jobs, “m” is the number of processing hosts, “(n log n)” is the time required for a job sort routine, “m log m” is the time required for a host sort routine, and “n*m” is the time required for match jobs and hosts. Existing art queuing systems build a master job queue, a master host queue, and then a master job queue by matching job and host. The cumulative time to sort and dispatch is called the job dispatch time. Most queuing systems run the sort and dispatch routine periodically, often called a “time out”, “collect and analyze”, or “fixed period” approach. Using a single processing thread in the management daemon, job submissions are typically “insert sorted” (the “n log n” component) upon receipt to produce an updated job queue. The hosts are then sorted and matched with jobs (the“(n log n)” and “(n*m)” components, respectively) to build a master job queue. The host sort and match computation uses a separate processing thread that runs periodically. Queuing performance can be improved by “filtering” to delete jobs already being processed and to delete unavailable hosts before running the sort and dispatch routine, which produces the revised equation: T(n,m)=[(n−i)*(m−j)]+[(n−i)log(n−i)]+[(m−j)log(m−j)], where “i” is number of jobs removed from list, and “j” is the number of hosts removed from list. There are typically more jobs than hosts, so the job sort routine typically takes more time than the host sort routine.

Even optimized by filtering, the existing art of sort and dispatch has at last seven major problems: (1) the job sort routine could take longer than the interval between periodic host sort routines, called a job sort overrun condition, which is normally fatal to dispatch; (2) the sort and dispatch routine is run periodically, even if unnecessary, which can result in delays or errors in completing other supervisory tasks, e.g., missed messages, failures to reply, and hung threads; (3) an available host may experience excessive delay before receiving a new job because of the fixed interval on which the sort and dispatch routine runs, called a “host starvation” condition; (4) the sort and dispatch routine is asymmetric and must be executed on a single processing thread; (5) the number of jobs that a queuing system may reasonably handle is limited strictly by the amount of time it takes to execute the sort and dispatch routine; (6) the existing art produces uneven service, particularly erratic response times to job status queries by end-users and erratic runtimes; and (7) uneven service offends and provokes end-users.

The speed at which a management daemon in a queuing system is able to match a job with a host and to dispatch the job for processing is the key to the performance of a queuing system. It is also very desirable for a queuing system to gracefully handle, without system administrator involvement, the insertion of “deadline jobs” into the system. Because most queuing systems use a fixed period scheduling algorithm (aka “fixed period queuing system”), it is impossible for them to easily accommodate deadline jobs or “sub-period jobs”. A “sub-period job” is one that takes less processing time than the time it takes to schedule the job for processing. A fixed-period queuing system may take note of a job submission data upon receipt, but typically builds a master job queue periodically, as explained above; only after a master job queue is built can the management daemon dispatch a job to a host for processing. Another drawback of fixed-period queuing systems is that a job sort and a host sort require a significant amount of processing power; and dispatch times increases exponentially for an arithmetic increase in jobs or hosts. This are very serious problems for large farms.

The most common method for sorting and dispatching a job in an existing art queuing system involves, in addition to job submission, job sort, host sort, and job/host matching, a dispatch program that builds a “wrapper script”. The wrapper script instructs the selected host to process the relevant job. An alternate method is to instruct a given host is to build an end-user graphic interface (“EUI”) that accesses libraries that contain (i) all of the types of jobs that are submitted to the existing art queuing system, (ii) execution scripts associated with each of the types of jobs and with each of the types of hosts, and (iii) the types of hosts available. The EUI solicits job-related data from an end-user and either classifies each entered job as a permitted type of job or rejects the job; if the job is a permitted type of job, the EUI selects an appropriate type of host, and selects an appropriate execution script for the type of host on which the job will run. The existing art solutions have two major problems. First, wrapper scripts, execution scripts, and EUIs are difficult to maintain across distributed systems. Most EUIs require an explicit path to the processing application during submission; if the network address of the processing application changes, jobs are misrouted. The second problem is maintenance of the EUI and the libraries. EUIs typically use a collection of utilities or tools, in fact, some EUIs are nothing more than a collection of tools and glue code. If multiple tools are used by a EUI, each tool must be periodically updated (maintained). If each tool on each webserver and/or end-user computer is not properly maintained, jobs cannot be submitted or processed.

Two or more jobs are sometimes related to each other, such as being different versions of the same content (e.g., different renderings using different color palettes or lighting effects), or parts of a larger project. It is therefore desirable to have a means of identifying relationships among such jobs to facilitate addressing all jobs as a group in order to move all related jobs to a different host, to kill all related jobs, to condition the handling of one job on the state of a related job, or to take some other action affecting related jobs. Taking an action affecting related jobs is called “inter-job coordination”. In all queuing systems that support inter-job coordination, it is very typical for users to reference jobs based upon a unique identifier. This identifier is normally an alphanumeric string (“string ID”) or a job name. There are several pitfalls associated with using either string IDs or job names for inter-job coordination. One drawback is that certain job relationships are impossible to establish without a job log file (a file in which job relationships are defined as the jobs are entered) and using the job log file to process each job's relationship hierarchy. Since a string ID or job name must be unique, it cannot be predetermined by the user, and must be assigned by the management daemon. To establish relationships between jobs using either a string ID or job name, it is often necessary for the log file or equivalent library support to be specific to a given work site to enforce naming conventions that prevent string ID or job name duplicates. A second inter-job coordination problem arises in archiving inter-job relationships so that they may be recovered and replicated. The same log files or libraries used to create the job relationships must be available to recreate the relationships for recovery and replication. If the log files or libraries are lost or otherwise inaccessible, the job relationships cannot be recovered or replicated. Even more serious problems are that earlier jobs cannot cross-reference later related jobs (a user or process doesn't know the string ID of a later job at the time of submission of an earlier job), and that the most complex namespace model is a job tree.

Queuing systems are often used with distributed farms (two or more farms interconnected by a wide area network) containing heterogeneous platforms. To accommodate heterogeneous platforms, command line interfaces are often used for process definition. A command line interface is simple, available on all common operating systems, and uses small messages (which present minimal loads to networks). Command line interfaces, however, do have shortcomings. First, some operating systems limit the amount of data transmittable to an executing program or script. This forces the application designer to hack around this by writing the data to a file, sending the file, opening the file on the target machine, and either executing the commands in the file or associating commands sent separately with the data in the file. It can be difficult to debug this method in actual production use. Another limitation is that the available commands, and syntax of command line statements, isn't standardized across platforms. Building interfaces that can generate and recover command line parameters and arguments is difficult. These limitations can make even a simple job submission interface difficult to build and to maintain. Using command line interfaces to manage heterogeneous platforms in a distributed farm is even more difficult. Nevertheless, using command line interfaces to manage distributed farms is a common method in the existing art, given the lack of a better solution.

There is an unmet demand for queuing systems that efficiently and dynamically allocate processing jobs among heterogeneous and homogenous platforms (especially in distributed farms), that can be adapted for use in different industries, that can provide flexible job dependencies and messaging between users and processes, and that solve existing problems in dispatch time, scalability, job grouping, user interfaces, and granularity.

### SUMMARY OF THE INVENTION

The Event-Driven Queuing System and Method (“EDQS”) invention uses a continually updated, event-driven, supervisory daemon together with one or more callback, event, process groups, job typing, message architecture, clients, workers, executors, and related functions, as described below, to solve the above-described problems in the existing art. The invention embodies innovative steps in (1) how messages are constructed to enable execution on heterogeneous platforms, (2) what messages need to be passed, between what processes or users, and at which points in a job's processing, (3) the level of granularity needed for a particular decision and for messages related to that decision, (4) how to dispatch jobs without building a master job queue, and (5) how to build and continually update a supervisory daemon responsive to events and triggers characteristic of farms. In its preferred embodiment, the EDQS is built with object-oriented programming (“OOP”) code. OOP terms well known in the art, such as object and container, are used herein. The EDQS invention can be built and implemented using other programming language models that provide functionality equivalent to that described herein.

The job allocation and management component of the supervisory daemon of the EDQS invention maintains an inventory of all resources available for assignment for processing jobs. A “job” in the EDQS invention is a container that contains the parameters required to execute a task on a host. The term “job” is often used herein as short-hand to mean the task to be executed. Where appropriate, the phrase “job container” is used to distinguish the OOP container from “job” in the sense of “task to be executed”. The term “job package” means the “package information”, i.e., the information required to execute the task; job package has a defined data structure. The term “supervisor” means a host that runs, among other software, a “supervisory daemon,” as explained below. The term “worker” means a host on which a job is processed. A worker in the EDQS invention runs, among other software, a “worker daemon” and one or more “executors,” as explained below. “User” means either a human end-user (“end-user”) or a process. The EDQS supervisory daemon (“supervisory daemon”) may be hosted on its own server or another server in the farm network.

The most constrained resource in a farm is normally computational; computational resources can range from a single CPU workstation to a cluster of multiple-CPU supercomputers. To match processing jobs with resources, the supervisory daemon solicits information, such as the job type, action to take upon occurrence of certain “events”, notifications, whether the job is divisible, dependencies (e.g., run job D only after jobs A, B, and C complete), deadlines, etc., from the user submitting the job. The supervisory daemon determines which computational and other resources are suitable and available for processing the job, and then builds a series of messages that, when delivered and executed, will initiate and prosecute processing of a job.

To enable commands from the supervisory daemon to be executed on the various resources available over a network (“farm network”), the EDQS supervisory daemon constructs messages using semantics, syntax, and parameters specifically tailored to queuing batches of jobs and individual jobs, for instance in businesses such as semiconductor device design, printed circuit board design, computer graphics, proteomic, genomic, and other biotech modeling, automotive engineering, and other types of engineering. Such a machine-processable language, whose terms are derived from a domain model, is called a domain specific language (“DSL”). The domain specific language used in the EDQS invention is called the EDQS DSL. EDQS DSL interpreters installed as systems software on hardware resources translate EDQS DSL messages into commands that the relevant resource can execute.

EDQS DSL is also used for inter-process messaging within the farm network. Input from end-users who submit jobs for processing, and input from system administrators, is collected in an EDQS graphical user interface (“GUI”) and translated by the EDQS messaging application program interface (“MAPI”) into a message containing an EDQS DSL statement. Alternative user interfaces, such as command line, user process, and web browser can be implemented, but the preferred embodiment is a GUI coupled with a MAPI. The user interface typically collects information related to a job (“job attributes”) from a user, translates the job attributes into a “New Job” message, and sends the message to the supervisory daemon. The supervisory daemon exchanges a series of EDQS DSL messages with job processing hosts that run the EDQS worker daemon (such hosts are called “workers”), and the worker daemon executes instructions from the supervisory daemon using a supplementary process called an “executor.” Rather than use a polling and periodic process model of controlling execution (usually with a single-threaded host sort and dispatch routine), as is common in existing art queuing systems, the EDQS invention uses “events”, “triggers,” “callbacks”, and a multi-threaded supervisory daemon, each of which threads executes “callbacks”. A “callback” is a combination of an enabled “trigger” and executable code. A “trigger” is enabled when one or more “events” satisfy conditions defined for enablement of that trigger. Each “event” is an expression that contains one or more Boolean parameters linked to states of specified variables. The receipt of a New Job message, for instance, is an event that satisfies the condition required for the “Start Job” trigger, which in turn causes the Start Job callback to be executed. The Start Job callback involves, among other things, an exchange of EDQS DSL messages with a worker that will process the job associated with the Start Job message. Thus, the supervisory daemon is event-driven, and uses an “event/callback” method of job allocation and management.

The supervisory daemon monitors performance of each resource in the system. The system administrator can set the level of resource granularity at which the monitoring and adjustment of resources is done and can use the supervisory daemon to add, replace, or remove individual hosts assigned to a “node” (one or more aliased workers) optimized to process a given type of job. Such load balancing is done without interrupting jobs being processed. A change in job priority, resource availability, or other event that individually or in combination enables a trigger also causes the supervisory daemon to execute a callback; each callback typically involves an exchange of inter-process messages containing EDQS DSL statements.

The supervisory daemon also compares “job requirements” (resources required by a submitted job) with “worker resources”, using a linear search technique which usually produces a match between job and node immediately (depending upon node availability); if the linear search technique doesn't produce a match quickly enough, job and workers are sorted. The overall effect results in scalability that increases dispatch (the time from job submission to assignment of the job to a worker) time linearly as job or workers are added to a farm, versus the exponential increase in dispatch time in existing art systems. EDQS event-driven triggers can be used with the EDQS dispatch method so that a dispatch operation runs only in response to a “new job” trigger or a “node available” trigger; EDQS event-driven triggers avoid computation and delay of an existing art “n*m dispatch” and of most sorts.

The EDQS supervisory daemon is symmetric and can be easily threaded for faster response times and/or distributed over two or more supervisors. Parallel processing using symmetric threads gives the supervisory daemon the ability to handle large numbers of workers, jobs, and network routings simultaneously with uniform, predictable response. Predictable response increases end-user satisfaction. Because all dispatches are in response to a new job trigger or a node available trigger, compared to fixed period dispatches in other systems, EDQS event-driven triggers significantly reduce the workload on the supervisory daemon.

In the preferred embodiment, each worker is monitored for throughput, including workers aliased to the same node. This level of resource granularity enables the supervisory daemon to transparently add, replace, or remove individual computers from a node; the use of EDQS DSL statements facilitates the movement of individual computers among nodes, and the timing of such movement, to adjust node throughput. The EDQS invention also avoids the need to maintain wrapper scripts, tools, and glue code on end-user computers, and the need for a user interface to use an explicit path to the processing application during submission.

The EDQS invention allows a system administrator to define the behavior of a queuing system in three different ways: (1) interactively, by manually manipulating the priority of the jobs, and variables in the algorithms applied to match jobs to workers; (2) dynamically, by having the system itself to autonomously respond to events triggered by the processing of jobs, and (3) adaptively, by being able to change the behavior of the system based on evolving conditions without user intervention.

Existing queuing systems have not solved particularly intractable problems in responsiveness and in managing complex interdependencies between multiple jobs. The EDQS event/callback architecture and process groups enable complex interdependencies between multiple jobs, e.g., parent/child- and group-based, to be easily processed. The EDQS invention solves longstanding problems in existing art systems.

### BRIEF DESCRIPTION OF THE DRAWINGS

FIG. 1 illustrates a typical EDQS systems architecture for the computer graphics rendering domain.

FIG. 2 illustrates the major components in a supervisor.

FIG. 3 illustrates the major components in a client.

FIG. 4 illustrates the major components in a worker.

FIG. 5 is a flowchart of the steps in submitting a new job.

FIG. 6 is a flow chart of the steps in a CSPS job-driven dispatch.

FIG. 7 is a flowchart of the steps in a CSPS worker-driven dispatch.

FIG. 8 illustrates a job/node comparison routine without considering user-assigned priorities.

FIGS. 9A to 9B illustrate the results of a job/node comparison without considering user-assigned priorities

FIG. 10 illustrates a job/node comparison routine including user-assigned priorities.

FIGS. 11A to 11D comprise a table of the most common EDQS messages, message function, and outcome after a message fault.

FIGS. 12A through 12B is a diagram of message exchanges among client, supervisor, worker, and executor.

FIG. 13 illustrates job status variables and values.

FIG. 14 illustrates evtype variables and values.

FIGS. 15A to 15E illustrate typical events.

FIG. 16 illustrates the data structure of the agenda table.

FIG. 17 illustrates the data structure of the event table.

FIG. 18 illustrates the data structure of the callback table.

FIG. 19 illustrates the data structure of the subjob table.

FIG. 20 is a flowchart of the steps in executing a callback after a trigger is enabled.

FIG. 21A to 21C illustrate cross-referencing using process group labeling.

### DETAILED DESCRIPTION OF THE PREFERRED EMBODIMENTS

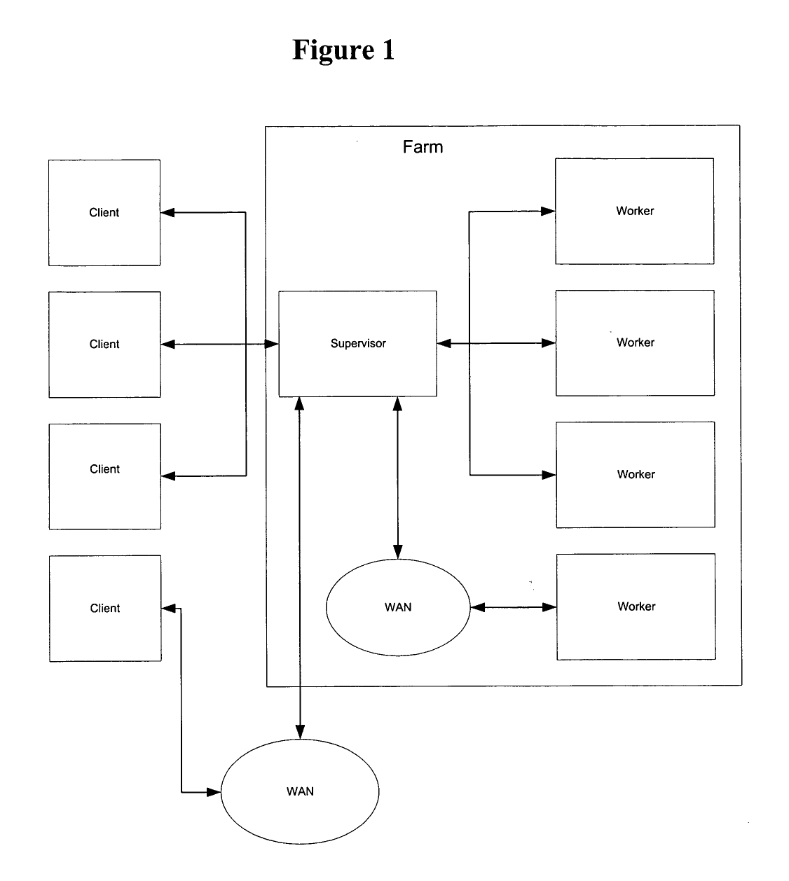

FIG. 1 illustrates a typical EDQS systems architecture for the computer graphics rendering domain. As will be explained in more detail below, in the EDQS invention, messages are exchanged between client and supervisor, supervisor and worker, and worker and executor.

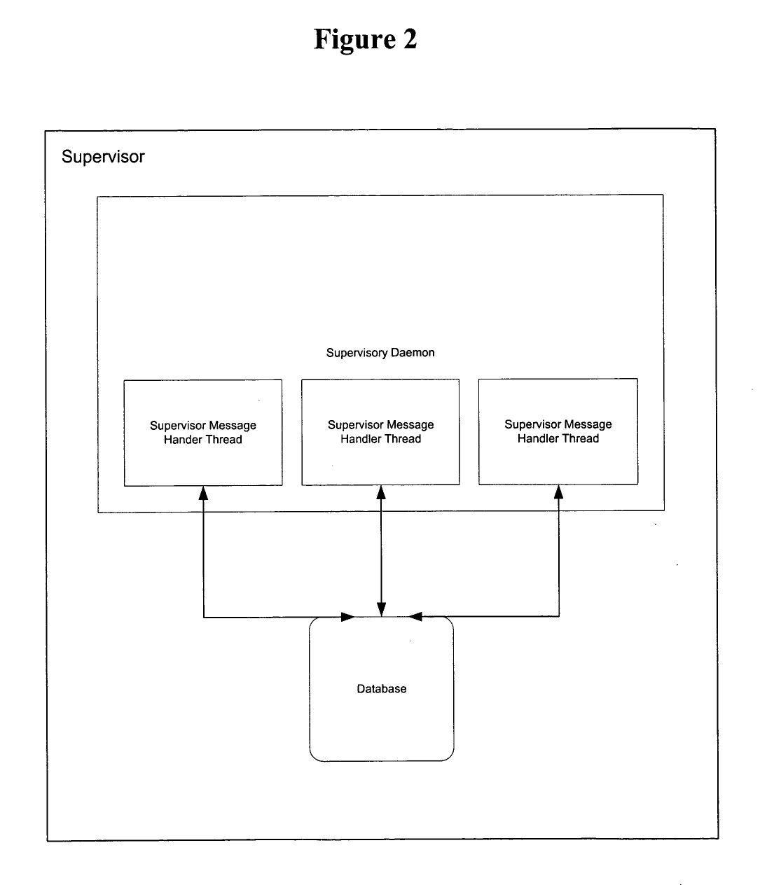

As shown in FIG. 2, a supervisor runs a supervisory daemon, and exchanges messages with at least one database, at least one client, and at least one worker using a supervisor message handler thread.

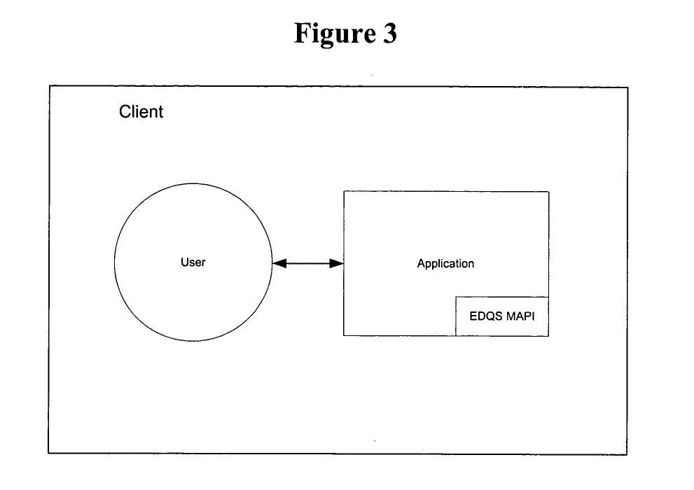

As shown in FIG. 3, a client contains a user, and in this illustration, an application with an EDQS MAPI plug-in. The EDQS MAPI exchanges message with the supervisor.

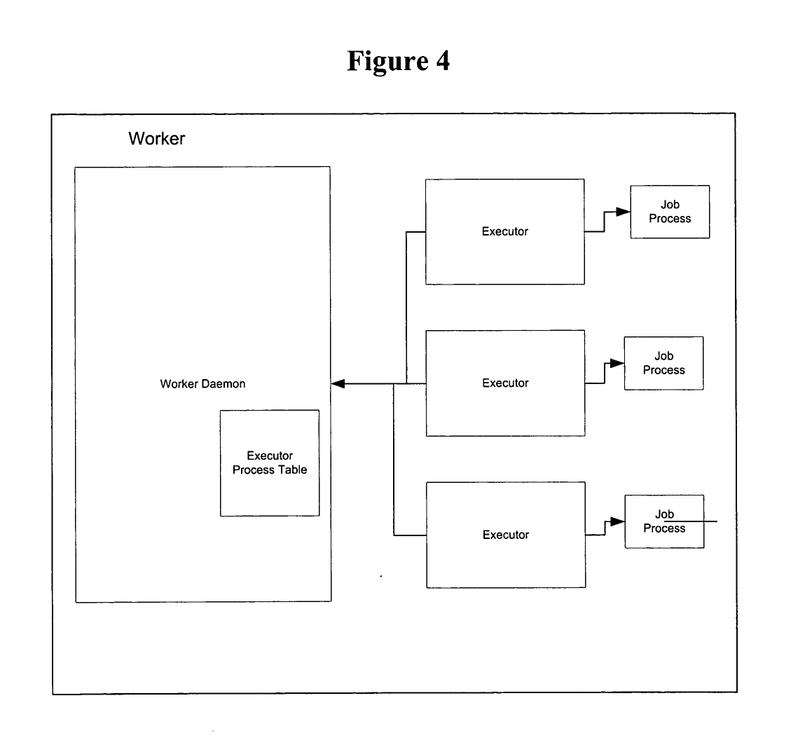

As shown in FIG. 4, a worker runs a worker daemon that exchanges messages with executors that have been spawned in response to jobs assigned to the worker. Each executor launches and tracks a job process. The worker daemon uses an executor process table to track the status of executors that it has spawned.

EDQS job routing. The method of routing a job from submission by a user to a worker that will process the job is of central importance in queuing systems. Job routing must factor in worker attributes (e.g., properties, worker capabilities), job attributes (e.g., requirements, restrictions), user attributes (e.g., priority), and administrative attributes (e.g., allocation of workers to nodes). Job attributes used in a preferred embodiment are classified as: (i) requirements, the logical expression of which must evaluate to Boolean true when compared with the properties attribute of a given worker before the relevant job can be dispatched to an available node with that worker; (ii) restrictions, which are used to restrict nodes based upon the job priority; and (iii) reservations, the local and global resources within the farm network the job intends to reserve while it is executing. Worker attributes used in a preferred embodiment are classified as (i) “capabilities”, attributes that must be tracked, such as availability and the physical address of the worker, and (ii) properties, the static or dynamic attributes of a worker, such as details about processor speed, memory, file systems, operating system version, etc. The supervisor uses worker attributes, job attributes, user attributes, and administrative attributes to determine, in a job-driven dispatch, which worker qualifies to execute an available job, and in a worker-driven dispatch, which job qualifies to execute on an available node.

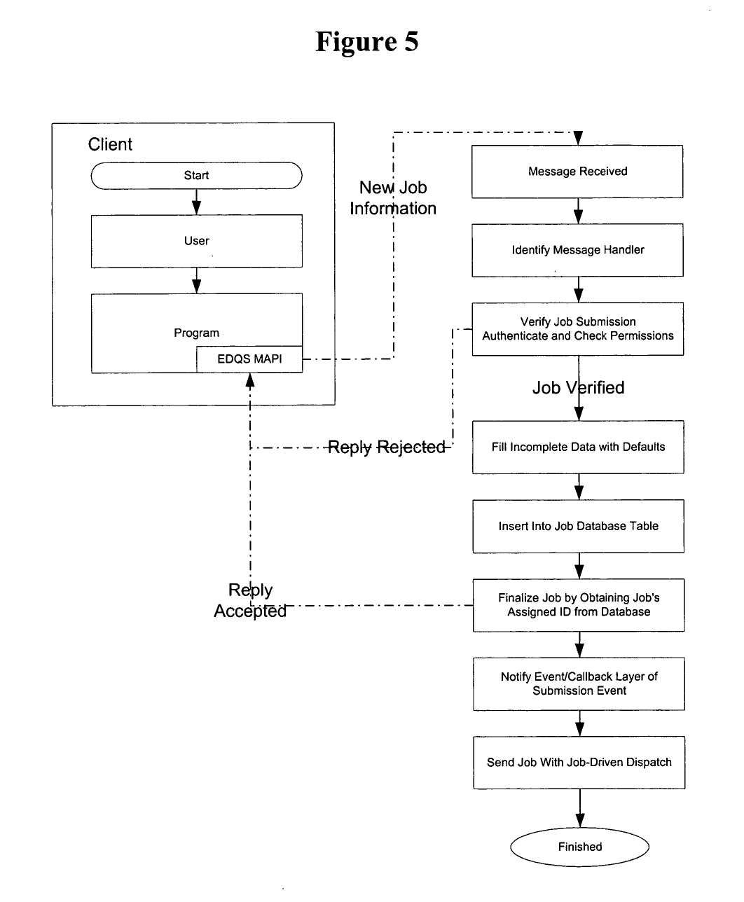

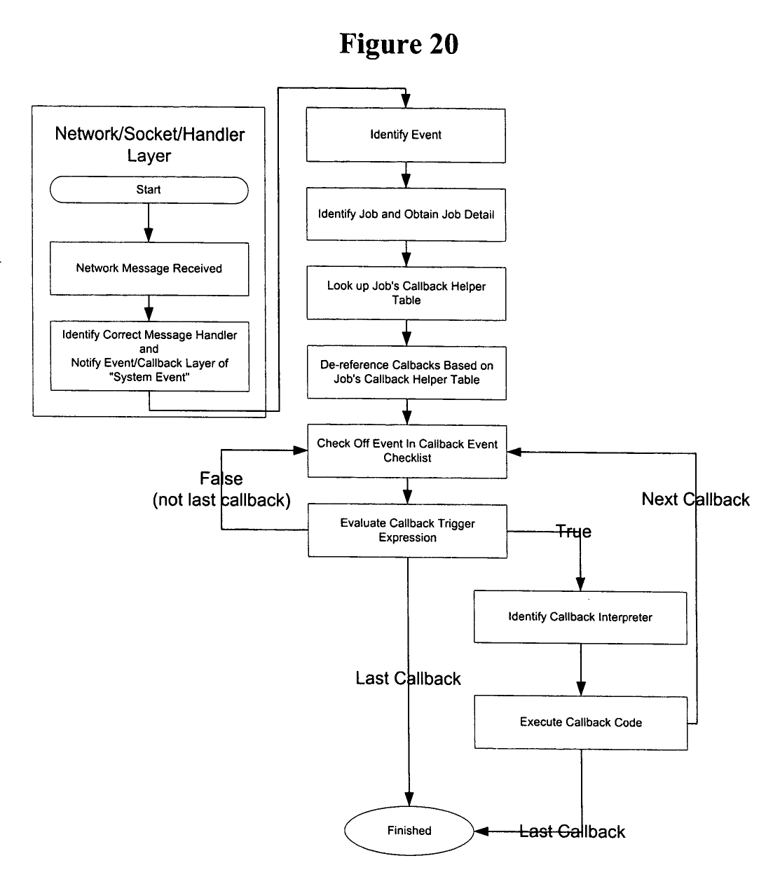

FIG. 5 shows the steps comprising “EDQS job routing”. From a client, a user submits a new job for processing. The submission is contained in a New Job message sent from the EDQS MAPI to the supervisor (a network/socket/handler process on the supervisor receives the message, as described in more detail in connection with FIG. 20). The supervisor inserts default values of attributes if a user omits such values in a job submission, and inserts the job into a job database. The job database assigns a job identification (“job ID” or “job id”), typically serially by time of receipt at the database; each job ID is unique. The event/callback layer is a process in the supervisor responsible for causing callbacks to be executed upon the enablement of a trigger, which is explained in more detail below.

To understand how radically EDQS job routing differs from job routing in existing art queuing systems, job routing in existing art queuing systems will be reviewed. All existing art queuing systems have a sort routine as a mandatory primary component of job routing. Sort routines used in queuing systems are typically governed by a comparison of “priority values” assigned to various computers used for processing jobs (each of which computers in an existing art queuing system is called a “candidate”) and priority values assigned to submitted but unprocessed jobs. Priority values are typically assigned to each candidate and job as numerals within a low to high range, where a high numeric value usually denotes high priority. Before assigning priority values, candidates must be assigned a network identity. A network identity is usually a text name that is mapped to a network address. Users typically submit their jobs for processing by specifying both a numeric priority and a preferred candidate; this is called a “job/candidate/priority” submission, where “job” is a job name, “candidate” is a processing host, and “priority” is a numeric or other value that can be compared in a sort routine. In some cases, there may be an administrative policy that a given user must submit jobs to a given candidate.

Rather than use the fixed network identity of a worker, EDQS job routing uses an aliased network identity, i.e., the supervisory daemon assigns to each worker a second network address, i.e., an alias or virtual node address, in addition to a worker's physical network address. A worker only has one virtual node address at any given time. However, and very importantly for load balancing, more than one worker may be aliased to a given virtual node address. Each such virtual node address is herein called a “node”; each node has a unique network identity. Under the control of a systems administrator, or of a load-balancing process, the supervisory daemon can increase or decrease the number of workers aliased to a given node. Aliasing more than one worker to a given node creates a cluster of computers on that node; the workers can be homogeneous or heterogeneous platforms. Aliasing a worker to a node provides improvements in three important areas: job-driven dispatch, worker-driven dispatch, and transparent and dynamic adjustment of the population of workers aliased as a given node.

The node specified in a job submission is called a “home node”. A job submitted to a home node typically has the right to use other computing resources (“foreign nodes”), however, the priority of a job submitted for processing on other than the home node may be lower in start rank and/or higher in preemption rank within such foreign nodes. Home nodes and foreign nodes are collectively called “nodes”, and individually a “node”. The term “start rank” means the rank of a given job in the queue of submitted jobs awaiting the start of processing on a particular node (assuming a queue has been built, as explained below). The term “preemption rank” means the rank of a given job among all jobs queued on a particular node (assuming a queue has been built) in having its rank lowered, or if a given job is being processed, having its processing interrupted, by another job with higher priority. In the existing art, the relative priorities of jobs on foreign nodes are often static and determined by a systems administrator.

The following are some of the defined terms used to describe the EDQS invention.

A “client” is the combination of a user and a user interface.

A “daemon” is a program that runs continuously and exists for the purpose of handling periodic service requests that a computer system expects to receive. A daemon forwards the requests to other programs (or processes) as appropriate.

An “executor” is a procthread launched by a worker as a result of running a job type executable.

A “job” is a container that contains the parameters required to enable a task to be executed on a worker and the course of events related to the submission and processing to be tracked. In a preferred embodiment, a job contains the job name, a job serial number (“job ID”), job requirements, job restrictions, job reservations, job package, job agenda, and the job typename. The “package” is a pointer to an arbitrary data structure that can be used to pass job information from the submission side to the execution side. The “typename” is simply a tag that describes what kind of job type to execute. The executor looks at the job type stored configuration file for the specified typename to retrieve the available options in launching the job. The data in the job type configuration specifies to the executor what executable to run, and what language binding to use in order to run the executable. A job always contains at least one sub-job. Each job container also contains a callback table and a callback helper table, and may contain an agenda table, and a subjob table The subjob table is used to manage the individual instances of a job in each individual worker to which a part of the job is assigned, for instance, when a job to render a series of animation frames is processed by more than one worker. Typically, all application software used to process a source file is entirely resident on a worker, and the supervisory daemon does a preliminary match of job and worker in a dispatch operation. In the preferred embodiment, the ultimate decision on suitability of an worker rests with the process spawned by the “check environment” executable specified in the job. Because the worker doesn't completely describe the execution environment of a worker, the check environment process spawned by the job determines if the execution environment of a given worker is completely adequate. Most of the time, a proper match between job and worker is made by the supervisory daemon, especially in embodiments in which a user can restrict during job submission the eligible workers by use of the restrictions attribute in the job container. The term “job” is used herein as short-hand to mean the course of events related to performing a task on a worker. When necessary to distinguish the job container from components related to processing, the specific terms (e.g., job container, etc.) are used. In alternative embodiments, a job container also contains OOP method executables related to routing and/or processing a task. When “job” is used herein in connection with existing art queuing systems, job has an existing art meaning of a task to be performed on a candidate. To eliminate the need to set up special cases when there are no subjobs, job containers with just one job typically denote the job as a subjob.

A “management daemon” is daemon responsible for scheduling and keeping track of all jobs in existing art queuing systems.

An “optimal match” is a system-defined variable used in comparing jobs and workers; the comparison variable typically used in worker's CPU speed, with faster being better. Other worker capabilities variables can be used as the comparison variable, e.g., file system, RAM, job processing application.

A “process group” is a group of jobs assigned as members of a group by the user or system administrator who submits a related batch of jobs. Process groups allow callbacks to contain a trigger definition that is specific to a given process group; the associated callback code, when executed, executes against all jobs in that process group. Callbacks can use cross-referencing among jobs in a process group and contain conditional branching based on the status of jobs within a process group. Individual job process group names are assigned by users or by a system administrator; the supervisory daemon assigns a unique number (“process group ID” or “process group id”) to each process group. The combination of process group number and process group name is therefore unique.

A “procthread” means a process spawned by the supervisory daemon or by a worker daemon.

A “sub-job” is a sub-container within a job which is atomic in assignment between a single worker and the sub-job.

A “suitable node” is a node with worker that matches a job's job type.

A “supervisory daemon” is daemon responsible for scheduling and keeping track of all jobs in the EDQS invention. It is also responsible for monitoring and reporting upon the status of each worker.

A “supervisor” is a computer that communicates with one or more workers and with one or more users over a network, and runs a supervisory daemon.

A “system-defined limit” is a value set by the system administrator.

A “user interface” is a graphical user interface, generic web browser, command line interface, or application plug-in that exchanges messages with the EDQS messaging application programming interface (“MAPI”). The user interface for a user other than an end-user, e.g., a process, is a process that exchanges messages with the EDQS user interface API.

A “worker” is a computer that communicates with a supervisor over a network, runs a worker daemon and application software used to process jobs, and engages in processing jobs. Each worker typically sends a “heartbeat packet” to its supervisor to indicate the worker's state (either available or engaged in processing).

A “worker daemon” is the resident daemon that runs on each worker. The worker daemon communicates with the supervisory daemon and is responsible for monitoring the status of the worker host (e.g., available for processing, engaged in processing, unavailable because of error condition), initiating the processing of jobs using application software running on the worker, and reporting to the supervisory daemon the status of jobs being processed.

A “worker list” is a list of all workers, and whether they are available to accept a job or unavailable, that is maintained by a database management system (“data manager”) that is capable of table locking.

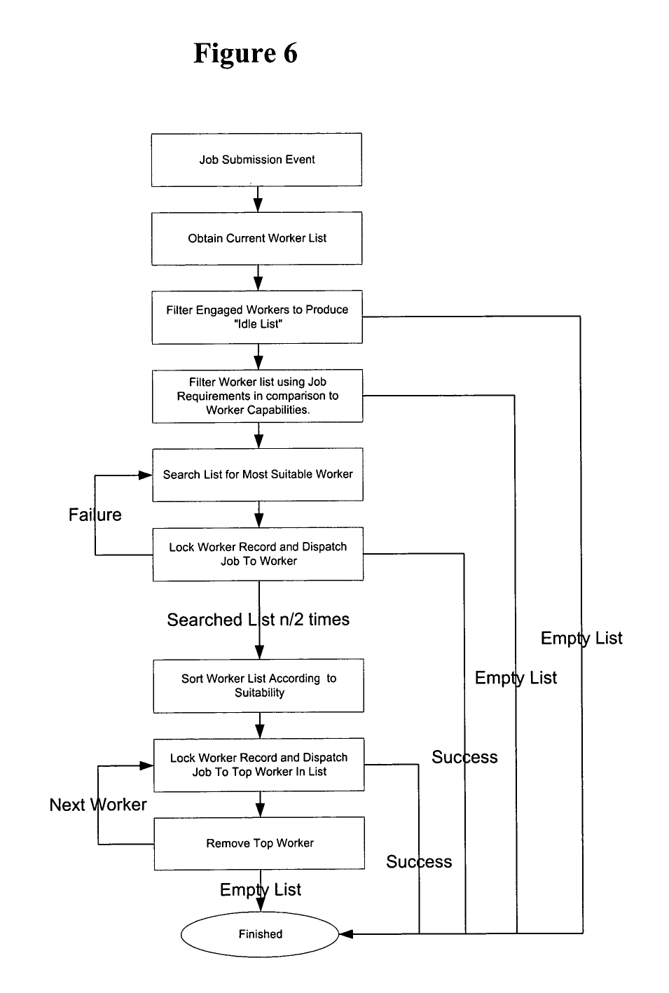

As shown in FIG. 6, to improve submission and dispatch performance, the EDQS invention uses a “compare, search, and possibly sort” (“CSPS”) method to match a newly submitted job with a node, or to match a newly available worker with a job. A job-driven dispatch is composed of the following steps: (1) the list of all workers in a farm is filtered to omit workers currently processing jobs (“engaged workers”) to produce an “idle worker list”; if there are no workers on the idle worker list, the job waits for a worker-driven dispatch; (2) the idle worker list is filtered by comparing the minimum job requirements with the worker capabilities of each idle worker to produce an “eligible worker list”, all of which eligible workers are a “suitable worker”. The eligible worker list includes in each worker's entry on the eligible worker list fields for the worker's capabilities and properties attributes, or one or more links to such attributes; (3) the supervisor searches the list of workers for the optimal match with the job. This search is in the order of O(n); (4) the supervisor dispatches the job to the worker with the optimal match; (5) in the preferred embodiment, the check environment runs to analyze the worker matched with the job; if the check environment process confirms a Boolean true when comparing the job requirements and worker capabilities, and that values of other attributes that are not included in the capabilities, including the physical address of the worker aliased to the node and other resource attributes, which other attributes are important to the job, are acceptable, the process sends a message to the supervisory daemon that the worker is acceptable (called a “preferred worker”). The message requests the supervisory daemon to assign the “preferred worker” to the job.

Next, the supervisory daemon requests that the database manager for the worker list database approve the request. The database manager locks the worker list database and searches for preferred worker. If preferred worker is on list and is available, the database manager grants the request, marks the preferred worker as unavailable on the list, and unlocks it; if the preferred worker is not on worker list when the request is received, the database manager denies the request, and unlocks list. If the database manager approves the request, the supervisory daemon exchanges messages with the preferred worker to confirm that adequate capabilities are currently available to process the job, and if the availability of worker capabilities is confirmed, the supervisory daemon informs the check environment process of approval and dispatches the job to the preferred worker; if the worker capabilities are not confirmed, the supervisory daemon denies the request from the check environment process and instructs the process to continue comparing entries in the eligible worker list (unless the system-defined limit for increment comparisons has been reached, as described below). If the database manager denies the request for the preferred worker, the supervisory daemon denies the request from the check environment process and instructs the process to continue comparing entries in the eligible worker list (unless the system-defined limit for increment comparisons has been reached, as described below).

The eligible worker list has not been sorted at this point, which saves the time and processor resources required to sort workers. If the embodiment does not use the check environment process, the worker commences processing the job, and if the processing fails, such failure constitutes the worker rejecting the job; (6) if the check environment process returns a Boolean false, the first entry on the eligible worker list is rejected (the “worker rejects the job”, since the check environment process runs on the worker), the supervisor receives messages from the worker that the worker has rejected the job, the supervisor dispatches the job to the next most optimal worker based on comparison, and the check environment process analyzes that workers capabilities and properties, and so on until a match of job and worker is made, or a system-defined limit is reached, typically n/2 comparisons of job and worker, where “n” is the number of jobs in the eligible worker list. An entry on the eligible worker list might be rejected if the job actually needs a higher value of an attribute than is specified in a given worker's attributes, e.g., a job might need the latest version of a given application program, and only the check environment process can confirm that the worker has the correct version; (7) if a match of job and worker has not been made after n/2 comparisons of job and worker, the supervisory daemon sorts the remaining workers (i.e., the workers for which a job to worker comparison has not been attempted) to produce a sorted list (i.e., a queue) of workers in order of one or more attribute fields, e.g., CPU speed, RAM, software version. There may be multiple workers aliased to a given worker, but the processor speeds, RAM, and rendering program versions may vary above the minimum values that define the suitable worker for a given node; and (8) after a sort of the remaining workers in the eligible worker list, the supervisor dispatches the job to the top-ranked worker and the steps from 5 through 8 repeat until a match of job and worker is made or the list is exhausted. If the list is exhausted, the job waits for a worker-driven dispatch. Importantly, the restrictions contained in a job type can be applied in step no. 2 to produce an eligible worker list that conforms to such restrictions. The job's reservation attribute is used by the supervisory daemon to decrement the amount of available capabilities on a worker when processing of the job starts on the worker.

To summarize CSPS job-driven dispatch steps:
Step 1. The worker list is filtered for availability to produce the idle worker list.
Step 2. The idle worker list is filtered using capabilities and requirements, restrictions, and reservations to produce the eligible worker list.
Step 3. The eligible worker list is searched, without sorting, for the closest match based on capabilities vs. requirements.
Step 4. The worker is then reserved in the worker list database. (Typically, this uses the record lock/unlock feature of a database management system.) Step 5. The supervisor dispatches the job to the worker.
Step 6. In the preferred embodiment, the worker checks the worker environment using the check environment process.
Step 7. The worker accepts or rejects the job. If the worker accepts, the worker processes the job. If the check environment process is not used, the worker commences processing the job, and if the processing fails, such failure constitutes the worker rejecting the job.
Step 8. If the worker rejects the job, messages to that effect are exchanged between the worker and the supervisor, the supervisor removes the worker from the eligible work list, the supervisor goes to step 3, and will loop back from step 3 to step 8 up to n/2 times if the job rejects the worker in step 7 in a given iteration.
Step 9. If, after n/2 tries to match a job with a worker there is still no match, the supervisor sorts the remaining workers and systematically attempts to dispatch the job to the first ranked worker, and if rejected, to the second ranked worker, as so on until there are no workers remaining on the list.
Step 10. If the eligible worker list is exhausted, the job waits for a worker-driven dispatch.

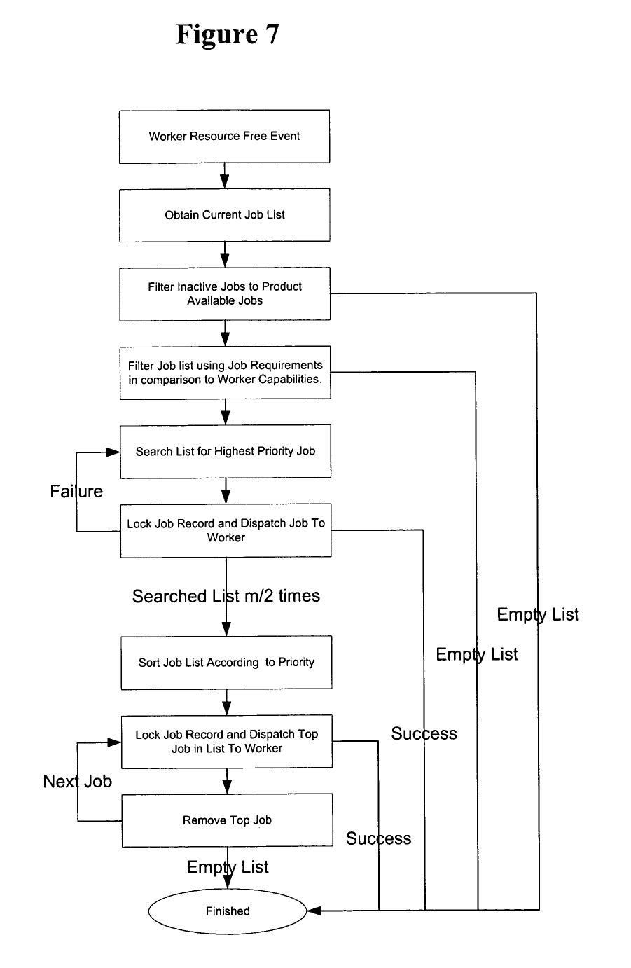

As shown in FIG. 7, a worker-driven dispatch comprises the following steps: (1) the list of all jobs in a farm is filtered to omit jobs currently being processing (“engaged jobs”) to produce an “idle job list”; if there are no jobs on the idle job list, the worker waits for a job-driven dispatch; (2) the idle job list is filtered by comparing the worker capabilities with the minimum job requirements of each idle job to produce an “eligible job list”, all of which eligible jobs are a “suitable job”. The eligible job list includes in each job's entry on the eligible job list fields for the job's restrictions and reservations attributes, or one or more links to such attributes; (3) the supervisor searches the list of jobs for the optimal job match with the worker. This search is in the order of O(n); (4) the supervisor dispatches the job to the worker; (5) in the preferred embodiment, the check environment runs to analyze the matched worker; if the check environment process confirms a Boolean true when comparing the job requirements and worker capabilities, and that values of other attributes that are not included in the capabilities, including the physical address of the job aliased to the node and other resource attributes, which other attributes are important to the worker, are acceptable, the process sends a message to the supervisory daemon that the job is acceptable (called a “preferred job”). The message requests the supervisory daemon to assign the “preferred job” to the worker.

Next, the supervisory daemon requests that the database manager for the worker list database approve the request. The database manager locks the worker list database and searches for worker and grants the request, marks the worker as unavailable on the list, and unlocks the worker list. If the database manager approves the request, the supervisory daemon exchanges messages with the preferred job to confirm that adequate capabilities are currently available to process the job, and if the availability of job capabilities is confirmed, the supervisory daemon informs the check environment process of approval and allows processing to begin on the worker; if the job capabilities are not confirmed, the supervisory daemon denies the request from the check environment process, instructs the job to wait, and goes to step 3 above to try to find another job for the worker (unless the system-defined limit for incremental comparisons has been reached, as described below).

The eligible job list has not been sorted at this point, which saves the time and processor resources required to sort jobs. If the embodiment does not use the check environment process, the worker commences processing the job immediately after confirmation of worker capabilities, and if the processing fails, such failure constitutes the worker rejecting the job; (6) if the check environment process returns a Boolean false, the first entry on the eligible job list is rejected (the “worker rejects the job”), and the check environment process analyzes the second entry on the eligible job list, and so on until a match of worker and job is made, or a system-defined limit is reached, typically m/2 comparisons of worker and job, where “m” is the number of workers in the eligible job list. An entry on the eligible job list might be rejected if the worker actually needs a different value of an attribute than is specified in jobs on the eligible job list at the time (only the check environment process, or when the check environment process is not used, attempting to process the job, can confirm that the job has the correct version); (7) if a match of worker and job has not been made after m/2 comparisons of worker and job, the supervisory daemon sorts the remaining jobs (i.e., the jobs for which a worker to job comparison has not been attempted) to produce a sorted list (i.e., a queue) of jobs in order of one or more attribute fields, e.g., software version; and (8) after a sort of the remaining jobs in the eligible job list, the supervisor dispatches the first ranked job to the worker, and steps 5 through 8 are repeated until a match of worker and job is made or the list is exhausted. If the list is exhausted, the worker waits for a job-driven dispatch. The worker's reservation attribute is used by the supervisory daemon to decrement the amount of available capabilities on a job when processing of the worker starts on the job.

To summarize CSPS worker-driven dispatch steps:
Step 1. The job list is filtered for availability to produce the idle job list.
Step 2. The idle job list is filtered using capabilities and requirements, restrictions, and reservations to produce the eligible job list.
Step 3. The eligible job list is searched, without sorting, for the closest match based on capabilities vs. requirements.
Step 4. The worker is then reserved in the worker list database. (Typically, this uses the record lock/unlock feature of a database management system.)
Step 5. The supervisor dispatches the job to the worker.
Step 6. In the preferred embodiment, the job checks the worker environment using the check environment process.
Step 7. The worker accepts or rejects the job. If the worker accepts, the worker processes the job. If the check environment process is not used, the worker commences processing the job, and if the processing fails, such failure constitutes the worker rejecting the job.
Step 8. If the worker rejects the job, messages to that effect are exchanged between the worker and the supervisor, the supervisor removes the job from the eligible job list, the supervisor goes to step 3, and will loop back from step 3 to step 8 up to m/2 times if the worker rejects the job in step 7 in a given iteration.
Step 9. If, after m/2 tries to match a worker with a job there is still no match, the supervisor sorts the remaining jobs and systematically attempts to dispatch the first ranked job to the worker, and if the job is rejected by the worker, the supervisor dispatches the second ranked job to the worker, as so on until there are no jobs remaining on the list.
Step 10. If the eligible job list is exhausted, the worker waits for a job-driven dispatch.

In an embodiment that uses the check environment process, the check environment process is performed by initializing the correct interpreter (in the case of a script; other programming language models can be used) for the language type specified in the job type, and providing the attributes of a given worker to the check environment process. The process evaluates the job's requirements in the light of the values of the worker attributes and returns a Boolean result. The check environment process operates the same in both job-driven and worker-driven dispatches.

In a job dispatch, the message exchange between the worker daemon and the executor begins with the receipt of a dispatched job (“Start Job” message) from the supervisory daemon. Upon receipt of the Start Job message, the worker is given option to accept or reject the order. The conditions in which this occurs are based upon whether the worker can satisfy the requirements of the job and comply with the job's reservations attributes. In the preferred embodiment, the check environment process executes on the worker and determines whether the job should work properly. If the check environment process approves the worker, an instance of the executor is launched with the job's ID and subjob ID as parameters. The worker daemon reverts listening for network messages and the executor processes the job, as follows. The executor decodes the job ID and subjob ID, then uses this information to send a network query to the worker that hosts the executor (the “launching worker”). In this query, the executor requests, and the worker obtains and relays, additional data about the job corresponding to the job ID and subjob ID. The additional data includes the job type of the job and specifies which interpreter the executor should launch. Based on the additional data, the executor selects the proper bootstrapping method that will present the job in a format the interpreter can interpret. For example, the bootstrapping method generates a Perl script that contains all the retrieved job data. The Perl interpreter is then launched and initialized with script generated by the bootstrapping method. The interpreter executes the script, which launches the job under the control of the executor. The executor then contacts the worker daemon and reports that the job, identified by job ID and subjob ID, is to be marked as “running”. In the event a problem is detected, e.g., job process crashing, it is the executor's responsibility to detect and report to the worker daemon a “failure.” The executor typically sends heartbeat packets to the worker to signal that the executor and its job have not crashed. In the event the executor crashes, its heartbeat packets stop, and the worker daemon assumes the job has failed, marks the job as failed, and sends a message to the supervisor to that effect. Each worker sends heartbeat packets to the supervisor to signal that the worker has not crashed. The worker periodically sends job status messages to the supervisor so that the supervisor can track workers and jobs.

The CSPS method normally matches a job and a worker on the first try. In the worst case search scenario, the supervisory daemon searches through the entire list of available workers n times. To balance the risk that a linear search will not find a suitable idle worker or job, as the case may be, versus the cost of the search, the linear search is only repeated up to n/2 times. If the job is not dispatched after n/2 searches, the supervisory daemon prepares and executes a sort. So, at best, the performance after filtering and using a linear search of suitable workers is O(n), and in a worst case, performance is O(n.sup.2).

If the system-defined limit for number of comparisons during a linear search is reached (typically n/2 or m/2 comparisons), the CSPS method sorts the jobs and workers as follows. (If the system-defined limit for number of comparisons is set to “n”, the sort is not performed.) To prepare for a sort, the CSS method first compares a given job, worker by worker, (or vice versa in a worker-driven sort) to produce weights for each combination of job and worker. In the preferred embodiment, the CSPS sort is run only as part of a job-driven or worker-driven dispatch, and only then after a linear search has reached a system-defined number of comparisons. Depending on policy, typically set by the system administrator, all workers or a subset of all workers, and all jobs or a subset of all jobs, can be included in a CSPS sort. Jobs and workers are typically filtered based on availability, job attributes, and worker attributes, to produce an eligible worker list in a job-driven sort, or an eligible job list in a worker-driven sort. After a sort, the resulting queue is used as the basis for dispatch, as described above. In other words, if n/2 workers were sorted in a job-driven dispatch, the comparison of job with worker resumes at the top ranked worker in the queue; if n/2 jobs were sorted in a worker-driven dispatch, the comparison of job with worker resumes at the top ranked job in the queue.

A job-driven sort will be described, but mutatis mutandi, the description applies to a worker-driven sort. Assume for simplicity there is a hierarchical node tree, superficially resembling a Unix style directory structure, and that there are four workers, 1, 2, 3, and 4, each of which has an aliased network identity, as follows:

Worker 1 has an aliased network identity as the root node, written as “/”.

Worker 2 has an aliased network identity as the project 1 node, written “/project1”.

Worker 3 has an aliased network identity as the project 2 node, written “/project2”.

Worker 4 has an aliased network identity as the project 2 power node, written “/project2/power”.

Further assume that there are only two job submissions:
Job A with home node of /project1 (one hierarchical tier below root node), and
Job B with home node of /project2/power (two hierarchical tiers below root node and one hierarchical tier below project 2 node).
   Each node is actually an aliased network identity of a worker, as defined above.

As shown in FIG. 8, the job/node comparison routine in the preferred embodiment proceeds through all nodes to weight the first job by node, then through all nodes to weight the second job by node, until the last job. The job/node comparison is typically performed after filtering, starting from the root node.

The CSPS comparison method quickly determines how closely Job A, submitted using Job A's home node, matches a given node, versus how well Job B, submitted using Job B's home node, matches the same node. The normal increment of weight, when added, is 1. A comparison of the weights accorded each job allows the final result of equality or inequality to be determined numerically, within two machine instructions in most cases. After each job has been assigned its weight on each node, any sorting algorithm known in the art, such as bubble sort, insertion sort, or QuickSort, may be applied to sort jobs with reference to a given node by comparing job weights. The preferred embodiment uses QuickSort, (available, e.g., at www.nist.gov/dads/ HTML/quicksort.html). The results of the illustration would be that Jobs A and B are equally weighted on all nodes other than their home nodes; on /project1, Job A weight is greater than Job B; and on /project2/power, Job B weight is greater than Job A weight.

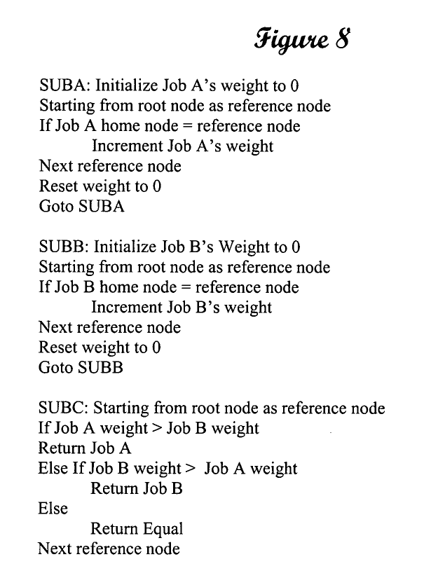

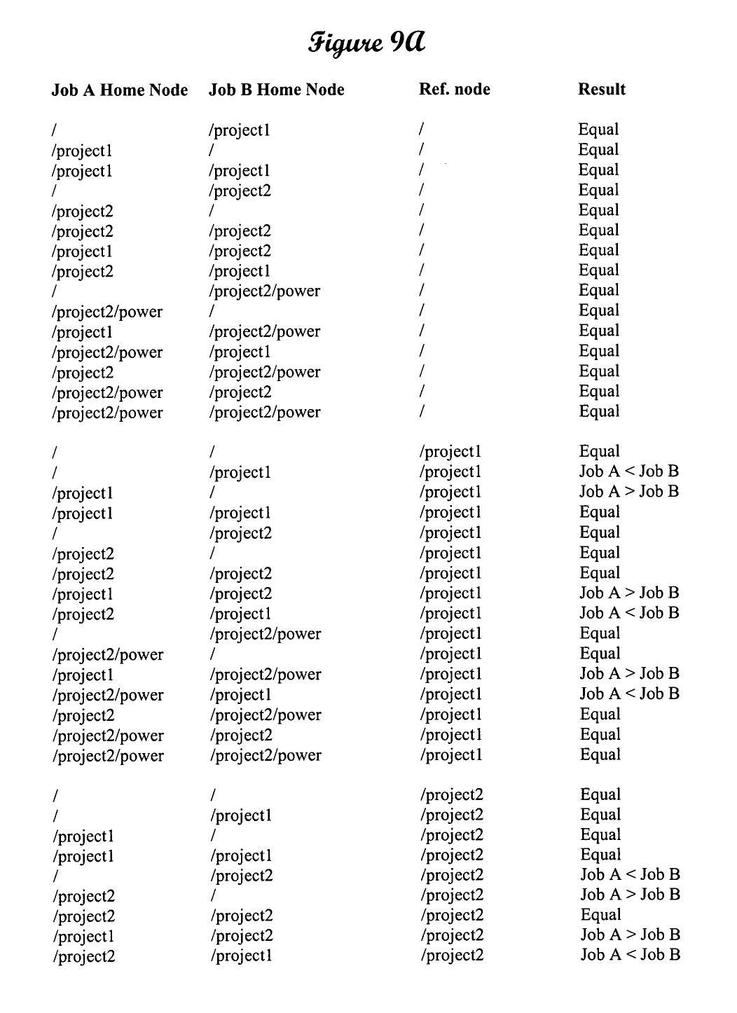

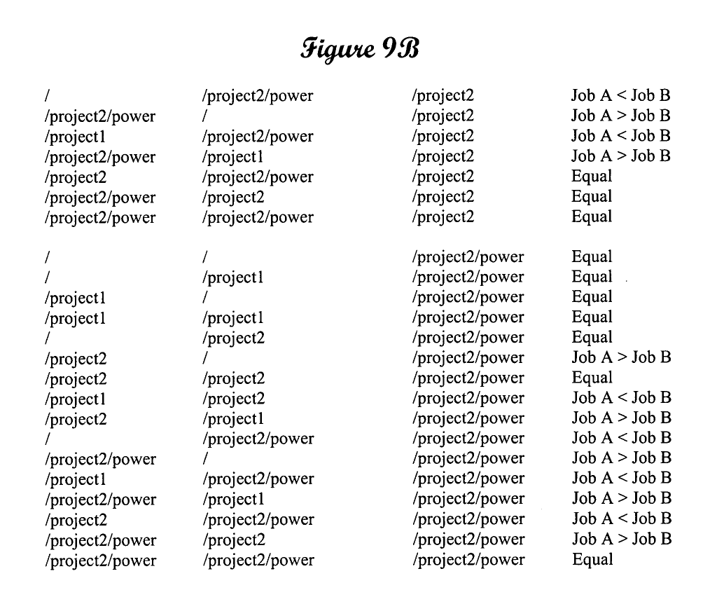

FIGS. 9A to 9B are an exhaustive illustration of the results of the job sort routine applied to Jobs A and B for all permutations of four possible home nodes (using the same nodes as in the previous illustration).

In practice there can be thousands of jobs and thousands of nodes in a farm, and the job sort routine is run for all jobs and nodes in the farm; optionally, before sorting, the jobs and nodes can be filtered to remove specific jobs, e.g., jobs that have too high a priority to interrupt, or all engaged workers.

Most queuing systems, including the EDQS invention, permit users to assign numeric priority values to a job during job submission. The use of numeric priorities permits a user to indicate how important the submitting user ranks the user's job relative to other jobs. The EDQS permits a system administrator to define how much weight user-assigned priority values should have in matching nodes, and therefore in a sort based on comparisons using priority values.

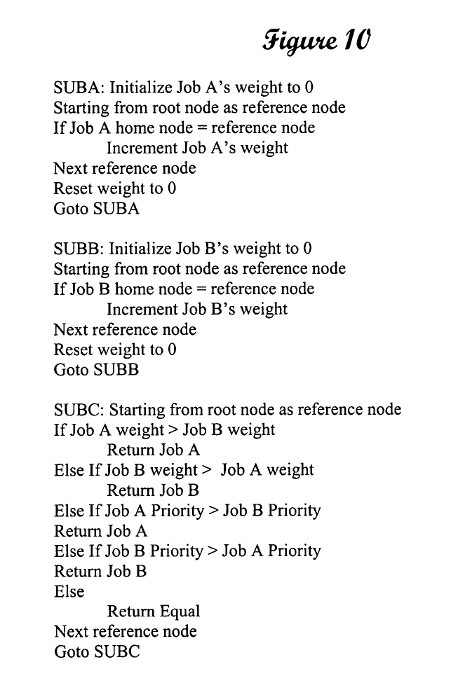

As shown in FIG. 10, to accommodate user-assigned priority values, to prepare for a job-driven sort, the CSPS method in the preferred embodiment proceeds through all nodes to weight and prioritize the first job by node, then through all nodes to weight and prioritize the second job by node, until the last job. Note in paragraph 3 of FIG. 10 that only if weights between two jobs are equal for a given node are user-assigned priorities considered. Mutatis mutandi, the description applies to a worker-driven sort.

The addition of the “Else If Job A Priority > Job B Priority, Return Job A; Else If Job B Priority > Job A Priority, Return Job B” statements in paragraph 3 provides relative reprioritization based upon a numeric priority, and only on nodes where relative weights are equal. This keeps the comparison function simple, which is very important because the performance of job sort routines is on the order of O(n log n). After each job has been assigned its weight and priority on each node, any sorting algorithm known in the art, such as bubble sort, QuickSort, or insertion sort, may be applied to sort jobs with reference to a given node by comparing job weights and priorities. If there is a tie in resulting sort order between two or more jobs, the tie is resolved by comparing each job's serial number, which is unique and sequentially assigned by the supervisory daemon upon successful job validation; a lower serial number has priority over a higher serial number.

The hierarchical nature of the CSPS method allows for more logical organization of resources on a project management basis. Different projects may be assigned a node designation. Because nodes are hierarchical, lower tiers of nodes beneath a given node can be used to break down project-related resources into sections and even down to “user nodes”. A “user node” is a worker aliased to a node used, by policy, primarily or exclusively by a single user. Since that single user specifies it as the user's home node, the user's rights on that node prevail over all other users, but if the user has no active job, the node is used as a foreign node by other jobs. Using a hierarchical group of resources for a given project (or other aggregation of jobs) is called “node grouping”. The ability of jobs to use as a foreign node a foreign node within a node grouping is called “job permeable node grouping”.

The comparison of job, node, weight, and priority in the CSPS method achieves the goal of maintaining administrative control while allowing job permeable node grouping with relative prioritization and preemption, and does so significantly better than existing art systems. The CSPS method allows a user to assign a priority value and specify a home node for each job, but also provides full utilization of foreign nodes and very efficient, transparent load balancing.

In the EDQS invention, when there is contention for scarce resources, filtering of workers is reduced to allow engaged workers to appear on the eligible worker list. A job with higher weight and priority will preempt a job currently using an engaged worker. In the preferred embodiment, the interruption will occur at a point in processing that minimizes problems in restarting the processing later, e.g., interruption at the end of rendering a frame. Alternatively, a job with lower rank can be interrupted immediately, and the processing resumed later from a point earlier in the processing of the interrupted job, e.g., starting immediately after the last full frame rendered. The CSPS method is advantageously used with the EDQS event-driver triggers and enables prediction of which job will be assigned to a given node at any given moment with a high level of certainty.

EDQS job type data architecture. The EDQS job type data architecture keeps logically associated data and code items together in a job type directory (aka folder), which greatly simplifies maintenance issues and also provides operational advantages. The minimum set of job type data items in a given job type element are: name of job type element (“descriptor” datum), name of execution file for processing the job (“executor” datum), name of the submission dialogue file (“GUI name” datum), name of job iconic representation file (“icon” datum), submission command line, including command line arguments (“commander” datum), binding scripts, names of associated libraries, and name of index file (described below). In the preferred embodiment of the EDQS invention, each job type element is a container, which in turn is a subcontainer in each EDQS job container. The job type directory also contains code files identified in the job type element, e.g., execution file, submission dialog file, job iconic representation file, binding scripts, index files, some or all of the associated libraries; the job type directory is typically stored on a supervisor.

Consolidating the job type data and code items in a single directory simplifies maintenance, since a list of data and code items in directory serves as a checklist for maintenance. For example, if the execution file is modified, both the GUI name and the commander often need to be updated, which is easier if the GUI name and commander are located in the same directory as the execution file. In the preferred embodiment, a job type element, populated with data, is an OOP job type object.

Use of EDQS job type elements and job type directories not only facilitates maintenance (e.g., distribution of maintenance releases and bug fixes) and interaction between end-users and system administrators with software designers and developers, but enables an improved, uniform data architecture, especially when using distributed production facilities. A job type directory can be easily compressed, moved among production facilities, and installed in identical logical locations in each production facility to enable uniform network addressing within each production facility and among production facilities.

The EDQS job type element can be advantageously used in combination with queuing libraries. A “queuing library” is a library of files used in processing jobs. The preferred embodiment of the EDQS job type directory contains an index file that outlines to the queuing libraries where to find relevant data items. The index file has a standard data structure to provide a uniform system of abstraction for application software, and contains meta data that describes the job type to application software, including data such as job author, version, and description. An example of a job type element is:
Job Type: commandline
Execute Requires File: execute.dso
GUI Requires File: submit.html
GUI Requires Icon: icon.xpm
GUI Requires Display File: display.html

Because all of the files associated with the job type element are located in the same directory and are identified by the index file, applications or objects such as a GUI, process interface, or worker are able to instantly find the files they require. The job type data architecture can optionally contain two additional features: “platform differentiation” and “location abstraction”. “Platform differentiation” means that each job type element specifies a different processing application execution file for each operating system (“OS”) on which the relevant processing application is hosted. The combination of job with a given processing application and platform is called a “binding”. An example of a job type element with platform differentiation is (N.B.: parenthetical operating system names are not included in an actual job type element):
Job Type: commandline
Execute Requires File: execute.dso (Linux)
Execute Requires File: execute.dll (Dos/Windows)
Execute Requires File: execute.dylib (Open BSD/OSX)
GUI Requires File: submit.html
GUI Requires Icon: icon.xpm
GUI Requires Display File: display.html

Platform differentiation enables the use of heterogeneous platforms in a farm without using scripting languages or virtual machine systems, such as Java, to context change the bindings. Rather than use interpreted binding scripts or recompiling bytecode, respectively, platform differentiation in the job type element allows the direct specification and use of binary application code. Binary application code is faster and more optimized.

“Location abstraction” means that a job type directory (a job type directory contains only one job type element, but, as explained above, the job type element can contain platform differentiation) can be hosted and used in several different ways. A job type directory can either be network mounted (hosted on a server in the network used by a farm) and accessed by a worker daemon, or a job type directory can be transmitted to the worker at run time. Because all information required to process a given job is provided by a job object and job type directory, a complete instruction to the worker daemon can be just a job object, which includes a job type element, and job type directory. Where job type directories are network mounted, a complete instruction to a worker daemon can be just a job object, which includes a job type element, and one or more job type directory paths; the job type directory path enables the worker daemon to look in several pre-established places for the job type directory. Providing alternative job type directory paths helps to minimize delays arising from network congestion, a server being off-line, or other causes.

The job type data architecture standardizes where and how a worker daemon on a given node finds the information needed to process a job, which reduces processing delays, supports distributed farms, and reduces maintenance. The worker daemon controls the processing software using such information. The job type data architecture is particularly advantageous in a large, distributed farm with heterogeneous platforms and in which there are many concurrent users of a given processing application.

EDQS messaging architecture. A messaging protocol and message processing (collectively, “messaging architecture”) used in a queuing system support two functions, fault tolerance and fault recovery, that are tailored to queuing systems. In the context of a messaging architecture, “fault tolerance” means that processing continues in an acceptable manner even after a message is lost or corrupted, and “fault recovery” means a method to obtain a replacement for the lost or corrupted message and or otherwise continue processing in an acceptable manner.

The EDQS messaging architecture uses a defined set of messages and protocol for exchanging messages between supervisors, workers, and user interfaces. A typical user interface for end-users is the GUI, although embodiments that use a generic web browser, command line interface, application plug-in, or other end-user interface known in the art can be implemented. User interfaces uses MAPI, which in the preferred embodiment is a component of EDQS messaging libraries, to convert messages into common networking protocols such as TCP/IP.

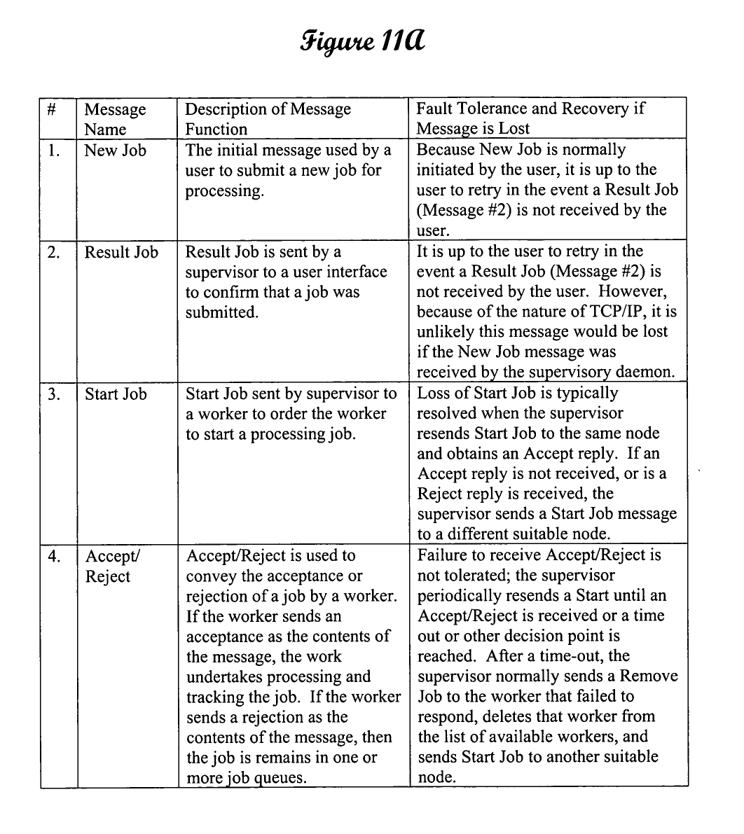

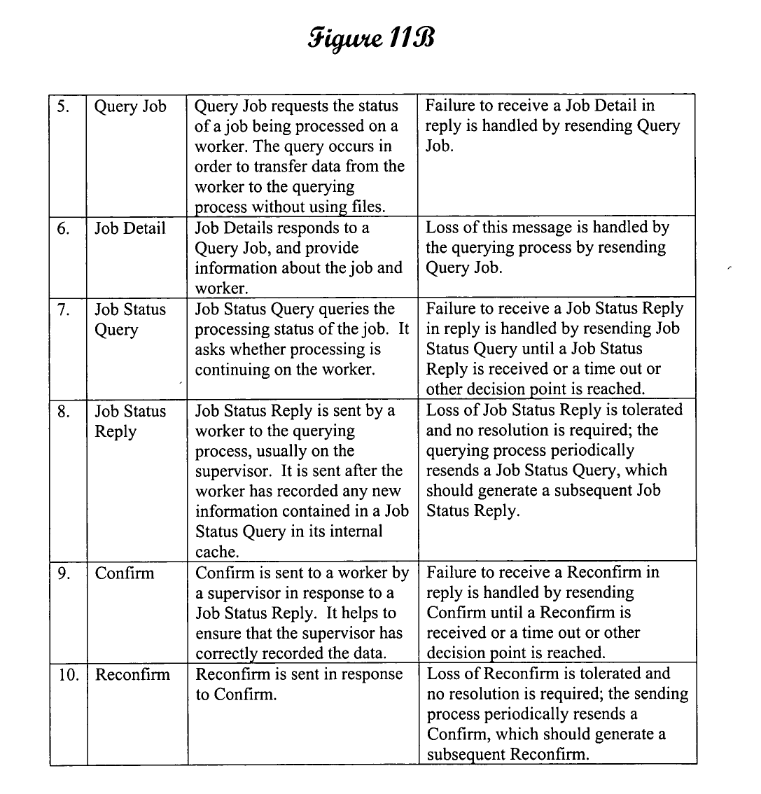

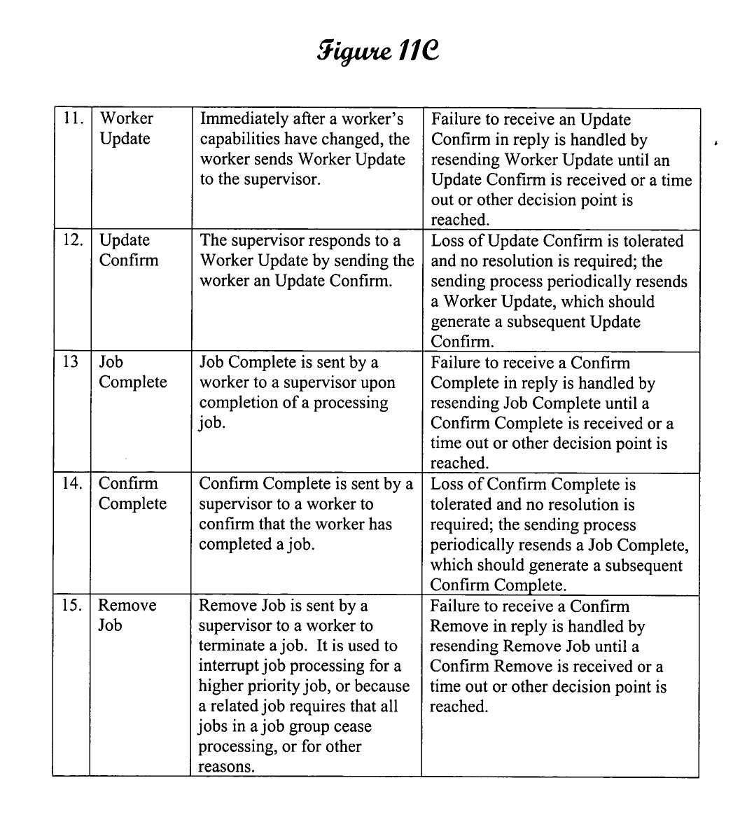

FIGS. 11A through 11D show the message names, the function of each message, and the fault tolerance and recovery if a given message is lost. A message names use initial capital letters. A “loss” means a failure of the addressee to receive a message.

The messages are dyadic and use a single TCP/IP connection. Failure in messaging normally occurs in the first message between a dyadic pair (e.g., in the New Job between a user and the supervisor, and in the Start Job between a supervisor and a worker) and not the reply, since the first message establishes a TCP/IP connection. The EDQS message architecture enables starting, tracking, and completing the processing of jobs and recovers from the loss of all messages except the first messages between a dyadic pair. EDQS messages are written to a message log maintained by the supervisory daemon that sent or received a given message.

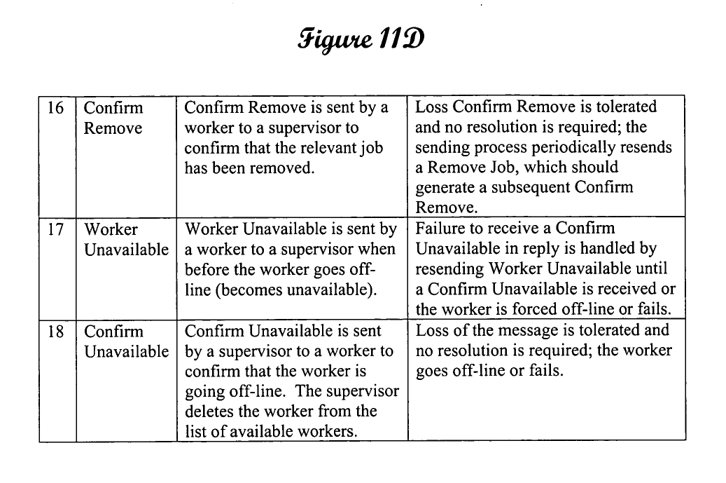

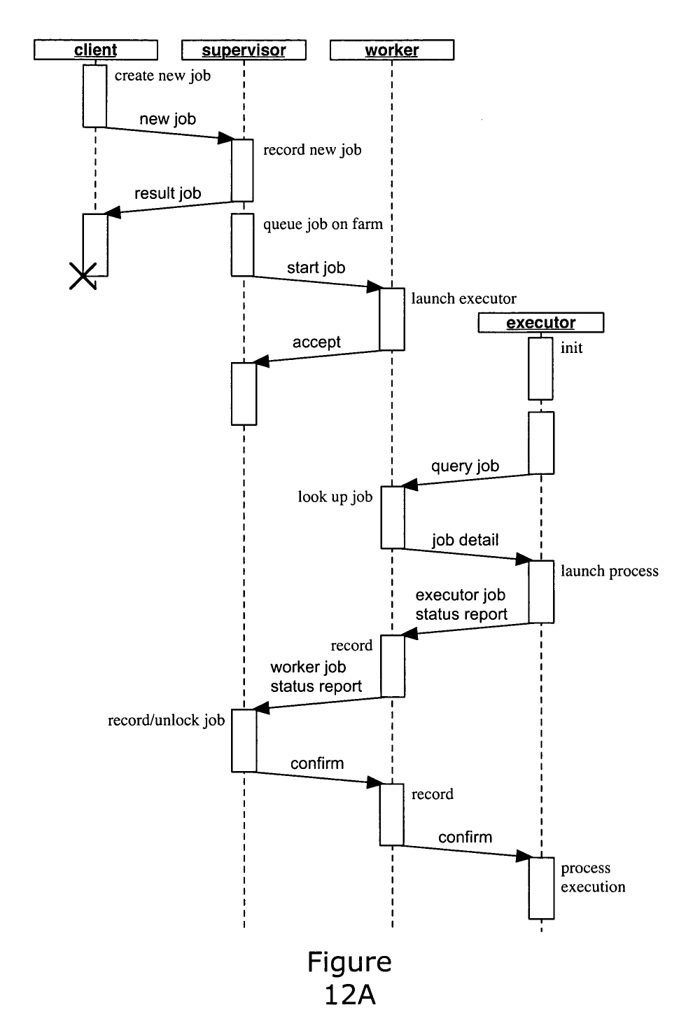

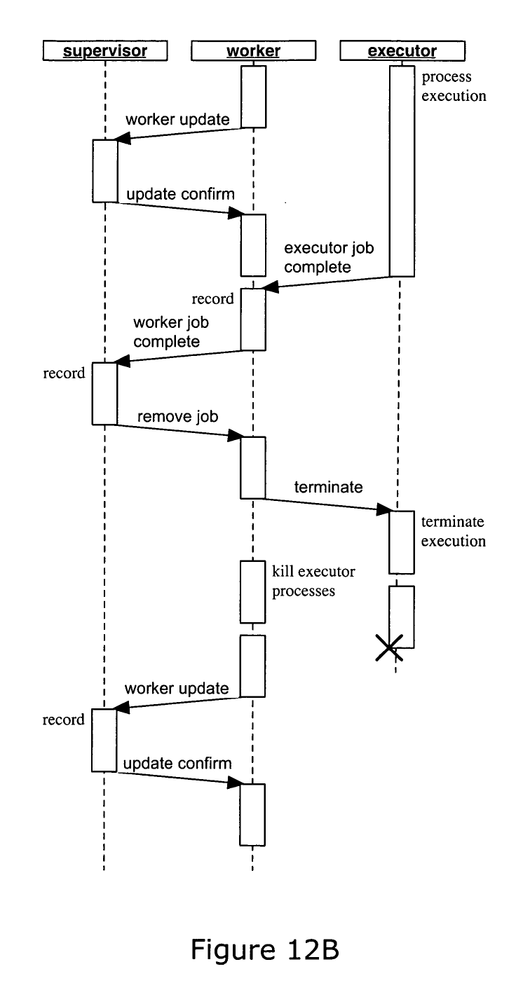

FIGS. 12A through 12B are a diagram of message exchanges among client, supervisor, worker, and executor. The illustrated messages (in sans-serif typeface) are those typical of a successful dispatch of a job to a worker and successful processing of the job by the worker. Comments on a step in FIGS. 12A and 12B are in serif typeface. In the event the job fails to complete processing for whatever reason (worker crash, memory violation, etc.), a different sequence of messages that reflect job failure would be exchanged after the job failure. Other messages can be constructed, such as through use of the EDQS DSL, and exchanged to accommodate the requirements of a given queuing system.

EDQS DSL. Managing heterogeneous platforms, especially those in distributed farms, is well-suited to the use of a domain specific language. To enable commands from the supervisory daemon to be executed on the various workers in a farm, the EDQS supervisory daemon constructs messages using semantics, syntax, and arguments specifically tailored to supervisors, workers, servers, operating systems, applications software, management software (especially queuing and farm management software), utilities, network protocols and devices, computer hardware, etc., used in a given “farm domain model”, e.g., queuing systems for processing semiconductor device design, printed circuit board design, computer graphics, proteomic, genomic, and other biotech modeling, automotive engineering, and other types of engineering. Such a machine-processable language, whose terms are derived from a domain model, is called a domain specific language (“DSL”). The domain specific language used in the EDQS invention is called the EDQS DSL. EDQS DSL interpreters installed as systems software on hardware resources, including without limitation, supervisors and workers, translate EDQS DSL messages into commands that the relevant resource can execute.

EDQS DSL is also used for inter-process messaging within the network used in a distributed farm (“farm network”). Input from users who submit jobs for processing, and input from system administrators, is collected in graphical user interface (“GUI”) and translated into EDQS DSL. The user GUI typically collects information related to a job (“job attributes”) from a user or system administrator, translates the job attributes into a job request (a job request comprises one more EDQS DSL statements), and sends the statements to the supervisory daemon. As explained below, the supervisory daemon builds a series of EDQS DSL statements that the supervisory daemon executes sequentially, subject to interrupts. In a preferred embodiment of the invention, each EDQS DSL statement to be executed is a record in a database.

EDQS takes advantage of the power and flexibility of object oriented language to “glue” code and data together, as well as to glue applications together by passing commands and data between applications. Third generation languages, such as C++, or scripting languages, such as Perl, include the ability to use complex data structures, such as scalars, associative arrays (aka hashes), and arrays. These data structures, when bound to queuing system supplied libraries, allows the queuing system to convey abstract data rather than command lines and command line parameters. The preferred language used to build the EDQS DSL is C++, together with a simple “C” library for script language binding. XML can also be used to build EDQS DSL. Different EDQS DSL statements contain data structures to submit a job, dispatch at job to a worker, to manage workers, generally to serve all messaging requirements in the EDQS queuing system. EDQS DSL statements are generated by a process, the EDQS DSL generator, and EDQS DSL statements are interpreted by a second process, the EDQS DSL interpreter. There is a EDQS DSL generator and interpreter for each platform used in a farm, which are also built using an object oriented language, preferably C++. The appropriate EDQS DSL message generator and message interpreter are installed, at a minimum, on each supervisor, worker, and GUI-equipped computer. The generator converts platform-specific commands into a data structure that can be interpreted by other types of platforms in the farm. The C or XML library contains the code used by the EDQS DSL generator and interpreter to generate and to interpret, respectively, EDQS DSL statements.

To illustrate an EDQS DSL statement, a command line statement is compared with the EDQS DSL equivalent. The effect of both statements is to cause a Unix operating system to list all files in the current directory in long format.

| Command Line | EDQS DSL |
|---|---|
| 1s -1a /tmp | Type: Directory List |
| | List => 1 |
| | Long => 1 |
| | 1 => 1 |
| | Directory => /tmp |

The EDQS DSL interpreter that reads the EDQS DSL statement is compatible with the platform on which it runs (Unix, Windows, etc.), and sends to its local operating system the correct command line statement. In the illustration, the interpreter on a Unix machine interpret the EDQS DSL statement and send the command “ls-la/tmp” to the operating system. The sender of the illustrated message does not need to know the type of platform on the receiver. The command, ls-la/tmp, seems to be a valid statement to send to another resource. However, because ‘ls’ doesn't exist on a Windows machine, the command will fail. With the introduction of the data structure used in the EDQS DSL statement, EDQS DSL interpreter on a Windows machine sends the proper command to “list all files, long format, in the current directory” to the Windows operating system. The EDQS DSL statement on the right is already parsed and ready for use by all resources in a farm, e.g., by all users for job submission, by the supervisor for interaction with users and workers, and by all workers. Since the contents of a EDQS DSL statement are plain text, and in a defined data structure, it is possible to recover the data very simply and quickly.

EDQS DSL statements enable the storage of as much data as is needed within the data structure of the statement. EDQS DSL statements can include a source file to be processed, or an EDQS statement can include the network path to the source file.

There are many advantages to using EDQS DSL. First, EDQS DSL eliminates quirky limits on command line parameters. Because the data structure in an EDQS DSL statement is handled outside of the command line infrastructure, it is possible to transmit anything, including entire files, as part of a EDQS DSL statement. EDQS DSL statements can include information about the job itself, such as any processing requirements and restrictions, and other important information that normally is the subject and several queries and replies in existing art queuing systems.

Another advantage of EDQS DSL is the ability to include additional code and/or data in a statement. For example, an executable may not be a command line statement, but a dynamic link library or a script that requires other executables or data. These other executables and data can be included to populate the data structure of a EDQS DSL statement.

EDQS event/callback architecture. The primary tasks of a management daemon in existing art queuing systems is to match jobs and hosts, dispatch jobs to suitable hosts, respond to requests from users for job status reports, remedy failures of hosts to process jobs, and route submitted and completed jobs. As described above, existing art queuing systems typically use a “collect and analyze” (aka “periodic dispatch”) sort and dispatch method that creates, and periodically recreates, a master job queue. The management daemons in existing art queuing systems also use polling extensively to collect information upon which conditional actions are based. For instance, each host is polled to learn whether processing of a job is ongoing or completed. Rather than use a polling and periodic process model of controlling execution of a management daemon (usually with a single-threaded sort and dispatch routine), the EDQS invention uses “events”, “triggers,” “callbacks”, and a multi-threaded supervisory daemon, each of which threads executes “callbacks”. A “callback” is a combination of an enabled “trigger” and executable code. A “trigger” is enabled when one or more “events” satisfy conditions defined for enablement of that trigger. An “event” is an expression that contains one or more Boolean parameters linked to states of specified variables e.g., the receipt by the supervisory daemon of certain messages from users or workers. Some of the important events defined in a preferred embodiment of the EDQS are described below. The receipt of a New Job message, for instance, is an event that satisfies the condition required for the Start Job trigger, which in turn causes the Start Job callback to be executed. The Start Job callback involves, among other things, an exchange of (in the preferred embodiment, EDQS DSL) messages with a worker that will process the job associated with the New Job message. Thus, the supervisory daemon is event-driven, and uses an “event/callback” method of job allocation and management. The supervisory daemon uses certain tables contained in each job container: each job container always contains a callback table and a callback helper table, and may contain an agenda table and a subjob table. The subjob table is used to manage the individual instances of a job in each individual worker to which a part of the job is assigned, for instance, when a job to render a series of animation frames is processed by more than one worker. The agenda table enables the system to match the granularity of the subjob to a given application on a given worker. As an example, the agenda table facilitates executing a single frame of a computer graphics animation on a rendering application's most efficient computational element, which may be several processors in a single computer chassis. Using an agenda table shortens runtime by feeding more elements to faster workers. The executor assigns each component of a subjob that is assigned to a computational element an “agenda ID” or “agenda id” to enable tracking of the subjob component.

The EDQS event callback architecture allows the system administrator to define the behavior of the system in three different ways: (1) interactively, by manually manipulating the priority of the jobs, and the matching of jobs and workers; (2) dynamically, by having the system itself respond to events triggered by the routing and processing of jobs, and (3) adaptively, by being able to change the behavior of the system based on evolving conditions, or an analysis of historic behavior, without user intervention.

The preferred embodiment includes a callback table and a callback helper table in the job container itself to minimize lookup time and to maximize flexibility compared with using a table external to the job container; using tables external to the job container is an alterative embodiment. “Callback table” and “callback helper table” are defined below, after a description of events and “triggers”. The EDQS invention also contains a global callback table and a global callback helper table to handle callbacks that are not associated with a specific job.

Generally speaking, an event is a change in the state of a hardware or software variable that can be reduced to a binary value, as such states are defined in “evtags”. Evtags are easily tailored meet user needs. Each evtag comprises three or more alphanumeric fields, each called an “evfield”, and uses a defined syntax. In the preferred embodiment of the EDQS invention, three minimum evfields are used: <evname>-, <evtype>-, and <evcontext>; optional evfields are denoted <evextra1>, <evextra2>, etc. A given <evname> value can be coupled with various <evtype> values, and each <evtype> can be coupled with various <evcontext> values, to create the evtags used by the EDQS invention. Equivalent methods known in the art to create a tiered taxonomy of variables and states can be used. Each evfield in an evtag has a specific meaning and purpose. The term “event” technically means the event defined in the relevant evtag. The format of each evtag is as follows:
<evname><evtype>-<evcontext>[-<evextra1>][-<evextra2>] . . . [-<evextraN>]

The <evname> field contains a given event name. The <evtype> field values modify the <evname> field, usually narrow the scope of the event itself, and usually concern a phase or scope of job processing. The <evcontext> field values identify a given job, identify a given subjob in a job, or otherwise denote the context of the relevant event. The <evextra_> field values further modify the <evetype> or <evcontext> evfields, typically to restrict the scope or to more specifically denote a phase of job processing. All callbacks are executed in connection with the processing of a specific job (or subjob), so referential values of the <evcontext> evfield are strictly defined.

In the lists of the evfields below, “the job” means the job identified in the <evcontext> field of the evtag. The following <evname> evfields, and associated definitions, are used in the preferred embodiment.
memorylimit—the job has attempted to use more memory than the worker processing the job has allocated to the job
timelimit—the job has been running for longer than the processing time assigned to the job
submit—the job is submitted
failed—the job failed to complete its processing
complete—the job completed processing successfully
killed—a user (usually the submitting user) has killed the job
blocked—the job is blocked, i.e., in a state where it can not be set to “running” until it is unblocked.
running—processing of the job has started
removed—the job is removed from the job list.
suspended—the job is suspended, i.e., the job has signaled its active subjob processes to temporarily stop processing
waiting—the job is waiting for an available worker to execute a subjob on.
assigned—the job is assigned to a worker
done—the job is in one of three completion states: complete, failed, killed
modified—the job is modified
unknown—the job is unknown
timeout—the job has timed out

The following <evtype> evfields, and associated definitions, are used in the preferred embodiment.
job—the <evname> (of the given evtag) applies to the entire job
subjob—the <evname> applies to a single subjob
work—the <evname> applies to a single work agenda item
worker—the <evname> applies to a worker
time—the <evname> is based upon a specific time
repeat—the <evname> is executed on a periodic basis until the job is removed
global—the <evname> is global
globaltime—the <evname> is global and based upon a specific time
globalrepeat—the <evname> is global and is executed on a periodic basis

The following <evcontext> evfields, and associated definitions, are used in the preferred embodiment. The <evcontext> field is not necessary for global events.
<job label>—the value assigned to a given job in a process group; typically assigned by the submitting user (in the preferred embodiment, <job label> value is alphabetic (i.e., does not contain numbers)
self—the evtag applies to the job defined in the job container in which the evtag is contained; in the case of an evtag for a subjob, the evtag applies to a specific subjob of the job defined in the job container in which the evtag is contained. The “self” value makes it simpler to use prefabricated callbacks without modifying a callback to include a unique identifier, such as a job ID or job name, during job submission time.
parent—the evtag applies to the parent of the job defined in the job container in which the evtag is contained; in the case of an evtag for a subjob, the evtag applies to the job defined in the job container in which the evtag is contained. The value of “parent” in the <evcontext> field enables the use of “tree hierarchies”, e.g., parent, child, grandchild, etc. A job can be a member of a process group, as described below, as well as be the “child” of a parent job.
<job id>—the alphanumeric value of an explicit job identification number; all values of <job id> are unsigned, i.e., there are no negative values or values starting with a minus sign)

Illustrations of events are:

The event “complete-job-self” means that the self-referenced job (i.e., the job defined in the job container in which the evtag is contained) has completed processing.

The event “complete-subjob-self-0” means that subjob 0 of the self-referenced job has completed processing.

The event “complete-subjob-self-1” means that subjob 1 of the self-referenced job has completed processing.

The event “running-job-parent” means that the parent of the job defined in the job container in which the evtag is contained is being processed

The event “complete-subjob-self-*” means that all subjobs of a given job have completed processing.

FIG. 13 illustrates job status variables and values.

FIG. 14 illustrates evtype variables and values.

A “trigger” is set of conditions that must be satisfied before the callback can be executed, and in the preferred embodiment, a trigger is a set of Boolean statements that all must be true before the trigger is “enabled” and the associated callback executes. (Alternatively, triggers can be built in which the Boolean statements must all be false to enable the trigger.) The term “trigger” more accurately means the trigger defined in a trigger definition, as described below. Combinational logic other than Boolean can be used, but the preferred embodiment of the EDQS invention uses Boolean logic. Satisfaction of the Boolean logic of the events defined for a trigger enables the trigger (sets the trigger value to true). The Boolean notation format of a trigger definition in a preferred embodiment is at least the first, second, and last lines of the following list (additional lines are used for additional events and additional Boolean expressions):

<evtag> := <evname>-<evtype>-<evcontext>[-<evextra 1>]
<statement> := <evtag>
<statement> := ( <statement> )
<statement> := <statement> and <statement>
<statement> := <statement> or <statement>
<trigger> := <statement>

In the preferred embodiment, a trigger occurs when the Boolean expression defined for that trigger is true. For example, a trigger definition to start job D upon the completion of jobs A, B, and C would be:

<evtag> := complete-job-jobA and complete-job-jobB
and complete-job-jobC
<trigger> := Start JobD

The most common triggers are:

complete-job- self
complete-job- <label>
done-job-self
done-job-<label>
done-job-<label #1> and done-job-<label #2>
failed-job-self
complete-subjob-self-*
complete-subjob-<label>-<subjob id>

A callback is a trigger associated with code relevant to the trigger. In a preferred embodiment, a callback is an OOP object comprising a trigger and executable code specific to that trigger. The “trigger” is the Boolean expression that, when it evaluates to true, causes the code associated with the trigger to be executed. The callback table in a given job container contains (i) all triggers to be used for that job and (ii) the executable code associated with each trigger. The “callback helper table” facilitates callback referencing and contains, among other things, the Boolean state of all events used in all the “trigger definitions” contained in the callback table. This enables the supervisory daemon to quickly identify the events that have a Boolean state of true and to find the callbacks associated with those events through trigger definitions. The callback helper table contains pointers to such callbacks. In the preferred embodiment, each record in a job's callback table is a single callback.

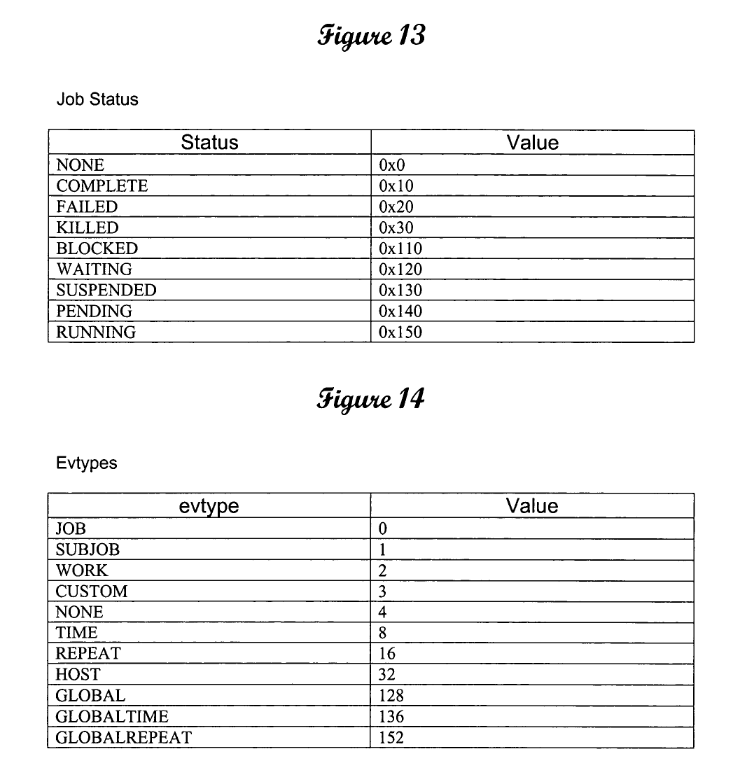

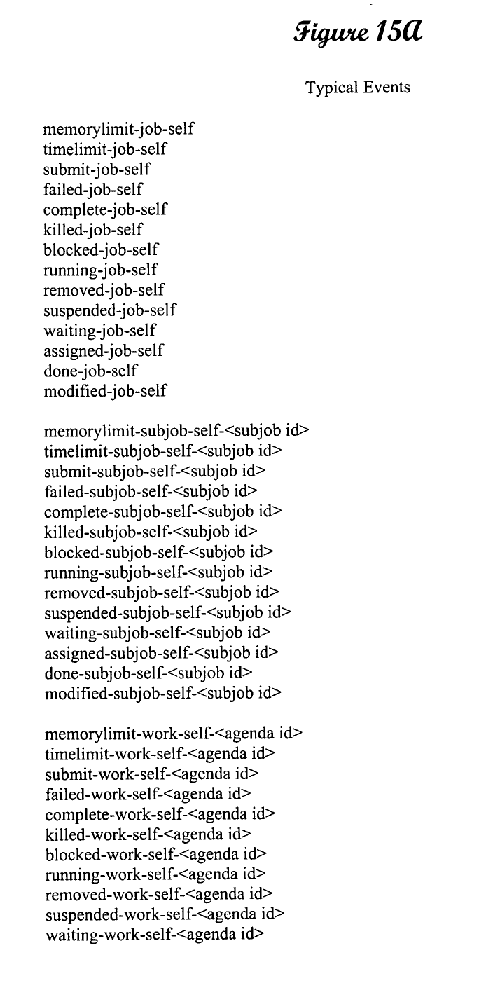

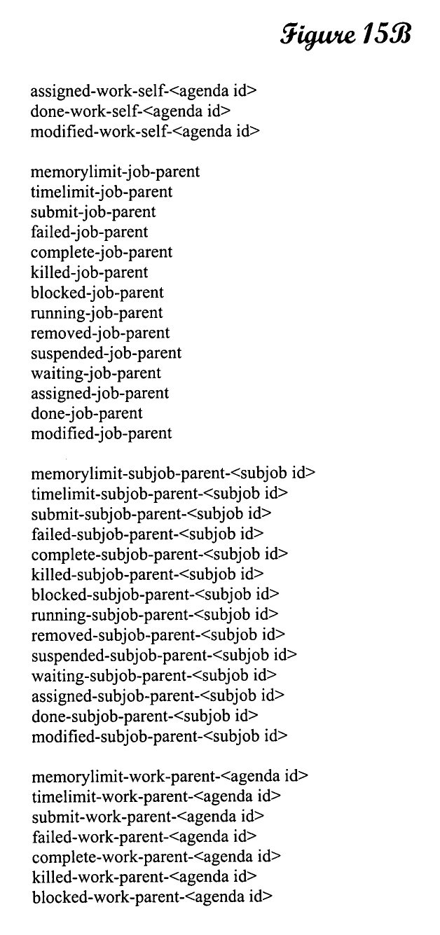

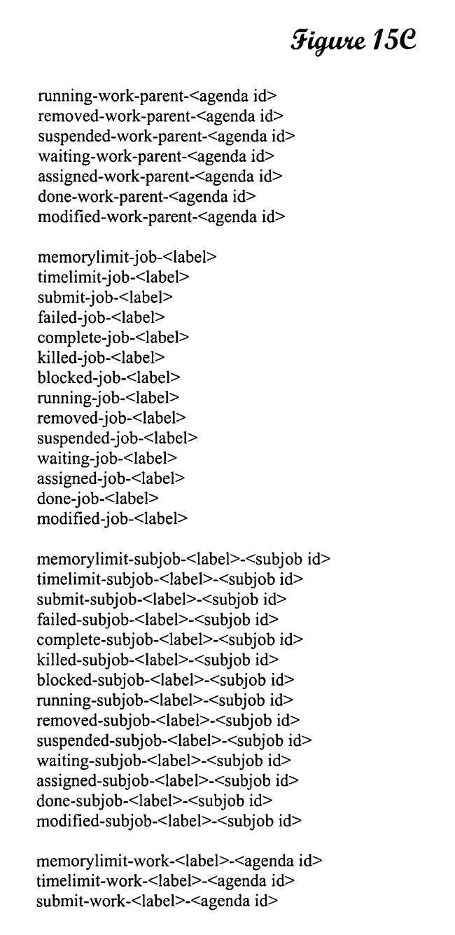

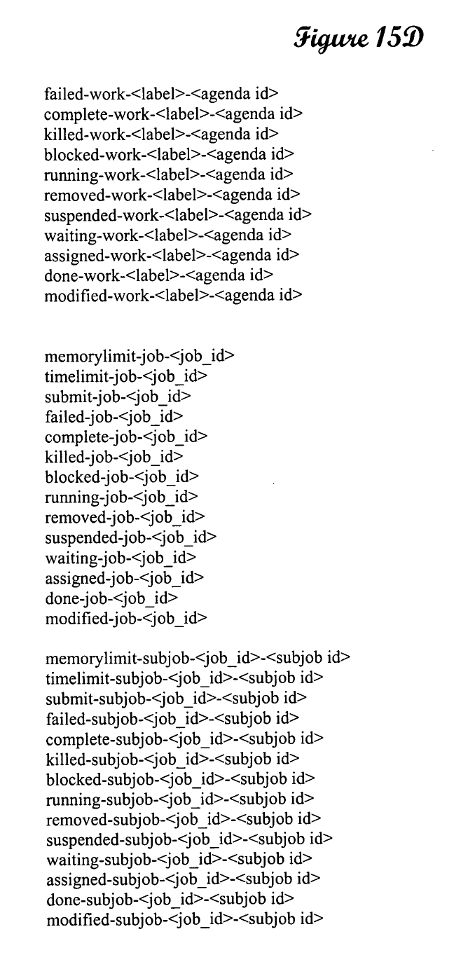

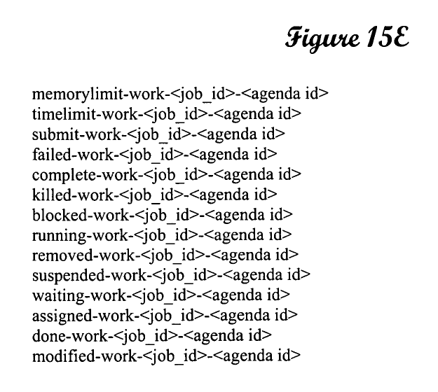

FIGS. 15A to 15E illustrate typical events.

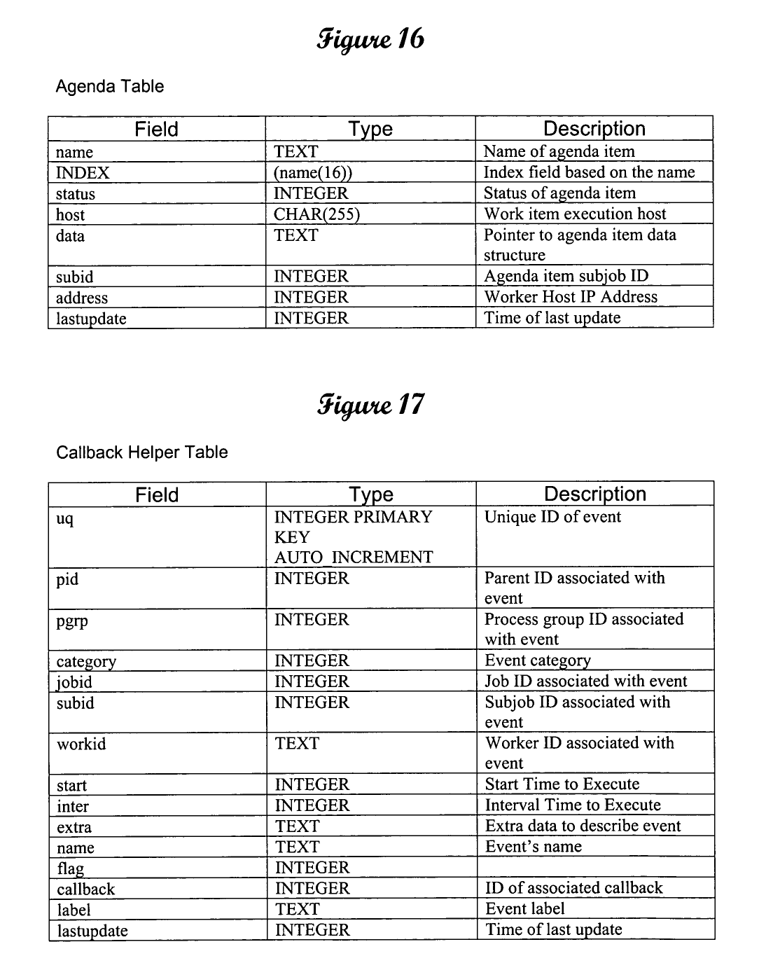

FIG. 16 illustrates the data structure of the agenda table.

FIG. 17 illustrates the data structure of the callback helper table.

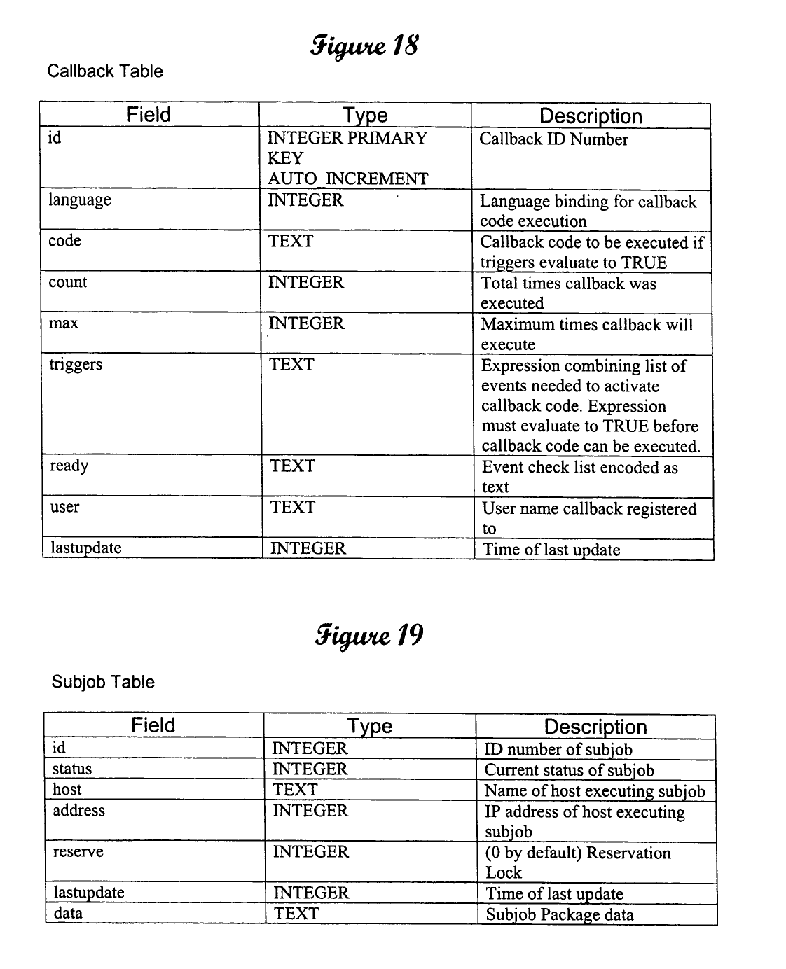

FIG. 18 illustrates the data structure of the callback table.

FIG. 19 illustrates the data structure of the subjob table.

The data structure of a callback requires the trigger and code components. Multiple variants of the code component, differing by platform, can be provided. Additional components of a callback are optional, as follows:
Language—Description of the type of machine code or bytecode, or of the source code scripting language, in which the one or more code variants are written
Count—Number of times the code has been executed
Max—Maximum number of times the code should be executed
Job—the job a callback is part of

FIG. 20 is a flowchart of the steps in used by a process, the “event/callback layer”, in the supervisory daemon to detect an enabled trigger and to execute the callback code contained in the callback containing that trigger. A network1/socket/handler, a process on the supervisor (which uses message exchange methods known in the art) receives a network message, identifies the correct message handler, notifies the event/callback layer. When a job is submitted, the user interface places in that job container's callback table the callbacks (i.e., the pairings of trigger definition and executable code associated with a given trigger) that the user intends to execute with the job. When the supervisory daemon (more accurately, the thread of the supervisory daemon that is active on the supervisor when a New Job message arrives at the supervisor) receives a given New Job message, the supervisory daemon analyzes (using the steps shown in FIG. 20) the trigger definitions of each callback in the job's callback table as part of the supervisory daemon's validation of a newly submitted job (“new job validation”). The trigger analysis will identify all the evtags that the supervisory daemon must track between submission and completion of the job. The supervisory daemon maintains a database that contains fields for all events the supervisory daemon must track (including fields for state values for each such event) and for the jobs that use a given event in their trigger definitions (“event database”). Entries in the database record of a given database include the memory location of the callback itself for interpretation by the appropriate script interpreter, execution by a dynamic library loader (or equivalent), or compiling by a virtual machine, as appropriate for a given platform.

After analysis of each trigger definition, the supervisory daemon creates a new job record in the event database and populates it with values for the events used in that job's callback table. The supervisory daemon also sets up in the job container's callback helper table a checklist for the relevant callback. Upon detection of an event, the supervisory daemon scans the event database for jobs that use that event (i.e., have the event in a job's callback table), and evaluates the trigger definitions of such jobs that contain that event (technically, that evtag) to determine if the just detected event enabled a given trigger. In cases in which one or more earlier events failed to enable a trigger (i.e., the trigger definition evaluated as Boolean false), a later event can supply the state change needed to enable the trigger; the earlier events are tracked as state values in the event database. In another preferred embodiment, state values of events are not tracked in the event database but in the callback helper table in the relevant job container. The trigger definitions in all callback tables of jobs that have been submitted but are not yet completed are searched for occurrences of an event that has been detected and then such trigger definitions are evaluated with reference to the new event and to the event state values in the callback helper table (or event database, depending upon the embodiment). Some events, such as a worker with attributes required for a given job becoming unavailable after previously being available, can cause a previously true state value in the event database or the callback helper table, depending upon the embodiment, to be reset to a Boolean false upon the supervisory daemon's receipt of a message that the worker is unavailable. Associating callbacks with jobs also simplifies the supervisory daemon's task of removing entries in the events database of jobs that are “done” (completed, failed, or killed).

In a different set of actions taken by the supervisory daemon upon detection of a trigger, the supervisory daemon identifies each job to which a given evtag in a given trigger definition refers (“referent job”). The supervisory daemon inserts into the referent job's callback helper table a reference pointer to the referring job's relevant trigger definition (the reference is typically to a given callback, since the trigger definition is part of the relevant callback). Unidentifiable referent jobs are inserted into a “lost event” table that allows the supervisory daemon to insert a reference pointer into the job's callback helper table when the job is identified (a trigger definition of a first job may reference a job that has not yet been submitted). During new job validation, the supervisory daemon also checks the “lost event” table to determine if it contains a reference to the newly submitted job, and if so, the supervisory daemon inserts a reference pointer into the newly submitted job's callback helper table to the referring job's relevant callback. The use of a “lost event” table enables dependencies, such as “Start Job D only after Jobs A, B, and C complete” even if Job D is submitted before Jobs A, B, and D. When one or more pointers (depending on how many references to the newly submitted job are in the lost events table) are added to the callback helper table of a newly submitted job, the relevant entry (or entries) for the newly submitted job is deleted from the “lost event” table.

Many EDQS DSL messages constitute events, e.g., New Job, Complete Job. Some events are based on elapsed time alone, e.g., a user-set limit for maximum runtime of a job. A user can define a callback that sends a message to the supervisory daemon based on any trigger definition relevant to a job (such as a maximum runtime, the expiration of which runtime without a Complete Job message constitutes an event, which event is the satisfaction of a trigger, which trigger causes a message to be sent instructing the supervisory daemon to kill the incomplete job, for instance). The supervisory daemon evaluates each EDQS DSL message to determine if it constitutes an event in the events database. Some messages, such as New Job and Complete Job, always constitute events. The supervisory daemon checks the job's event table and resolves the location of the callbacks referenced by them if there is a match between the event which has occurred and the record in the table. Upon finding each such event in the events database, the supervisory daemon evaluates the trigger definitions that contain that event to determine if the Boolean expression in the trigger definition is true. If the Boolean expression is true, the supervisory daemon executes the code associated with that trigger definition, and does so for each callback in which the trigger definition containing the detected event evaluates to true.

When a callback's trigger definition evaluates as Boolean true, the supervisory daemon creates a “callback handler” to cause the execution of the relevant callback. When a callback handler is created, a process is spawned in the supervisory daemon that uses the values in the fields of the relevant evtags to create an “execution context”. An “execution context” is the set of attributes based on data in the relevant job's job container, such as the job's process group, context information inherited from the job's parent, etc.

The supervisory daemon determines whether the code part of the callback to be executed is machine code or source code, and if source code, determines the source code language. If the code part of the callback is machine code, the code is identified appropriately (e.g., .dll, .dso, etc.) so that is matched with the supervisor platform; the supervisory daemon matches the type of machine code with the execution context and executes it. If the code is source code, the supervisory daemon sends the code to the identified interpreter (or bytecode compiler, in the case of embodiments that use virtual machines) for execution. Assuming the source code is a script, any well known scripting language, e.g., PHP, Perl, Python, Tcl, Scheme, or even custom scripting, can be used so long as the supervisor can provide the necessary language bindings for operations (e.g., upon state information) within the supervisor itself. The basic requirement of the code specification is that the supervisory daemon be able to load the code dynamically and to provide the executable with access to internal memory.

The execution context provides the language interpreters with additional information needed to support the script functionality, such as providing the job's identification and other attributes. The execution context also allows the system to enforce system security, e.g., preventing a user from modifying jobs that were not submitted by such user. In a preferred embodiment, callbacks include expirations and process sandboxing to prevent a callback from damaging the supervisor itself, e.g., by drawing all or unneeded processing power, by modifying local data to gain unauthorized access to the supervisor, etc.

By defining events, triggers, and callbacks within the EDQS event/callback architecture, end-users and system administrators have great range and flexibility in the ability to set conditions that cause the execution of code. Conditional execution of code using the event/callback model essentially changes the execution logic of the supervisory daemon, and provides a far more responsive and dynamic queuing system than the existing art. The EDQS event/callback architecture enables complex interdependencies between multiple jobs, both parent/child- and group-based, to be easily established and tracked; such complex interdependencies are virtually impossible in some existing queuing systems, and very cumbersome is others.

Process Groups. The ease of establishment of interdependency of jobs is shown in the example below. For ease of illustration, pseudo-code is used for the callback source code. Assume there two jobs, JobA, and JobB, and JobB must start after JobA completes. Both JobA and JobB have been submitted. The callback in JobB would simply be:
Trigger: On JobA Complete Code: Unblock JobB

When the supervisory daemon receives a Complete Job message from the worker processing Job A, the supervisory daemon evaluates the above trigger definition as true, causing the execution of the code. This illustrates two major advantages of the EDQS event/callback architecture: (i) no specialized data structure is need to handle the dependency; and (ii) since callback execution is event-driven, the supervisory daemon does not devote resources to monitoring, thus reducing overall load on the supervisory daemon.

A second example illustrates sending a text page to a job-submitting user (called an “owner”) when the user's Job A starts processing and to email the user when Job A completes.
Trigger: On Job A running Code: page “Job A is running” to owner
Trigger: On Job A complete Code: mail “Job A is complete” to owner

The code for mailing the user and for paging the user may not originally be a part of the supervisory daemon, but such code is easily added in the relevant callback as a script that the supervisory daemon interprets and executes. As the program code of a supervisory daemon is updated, commonly used callback scripts, e.g., “page Job <ID> is running” and “mail Job <ID> is complete” can be coded as part of the supervisory daemon program code, so that the callback script is simplified.

A third example illustrates using state values in the events database, thereby avoiding the existing art method of constantly polling for information. In this example, Job A and Job B have different completion points. To eliminate the need to set up special cases when there are no subjobs, job containers with just one job typically denote the job as a subjob. In a typical embodiment of an EDQS queuing system, a default rule is that all subjobs in a job container must complete before the supervisory daemon changes the state value of the job as a whole to “completed”. In the following example, completion of Job A causes all subjobs in Job B to be marked as completed, and therefore Job B to be marked as completed, whether or not all subjobs in Job B have actually completed. To implement this, the callback in Job B would be (a callback is not needed in Job A, which will process normally):
Trigger: On Job A Complete
Code: For each subjob in Job B, if subjob still pending, mark subjob as complete

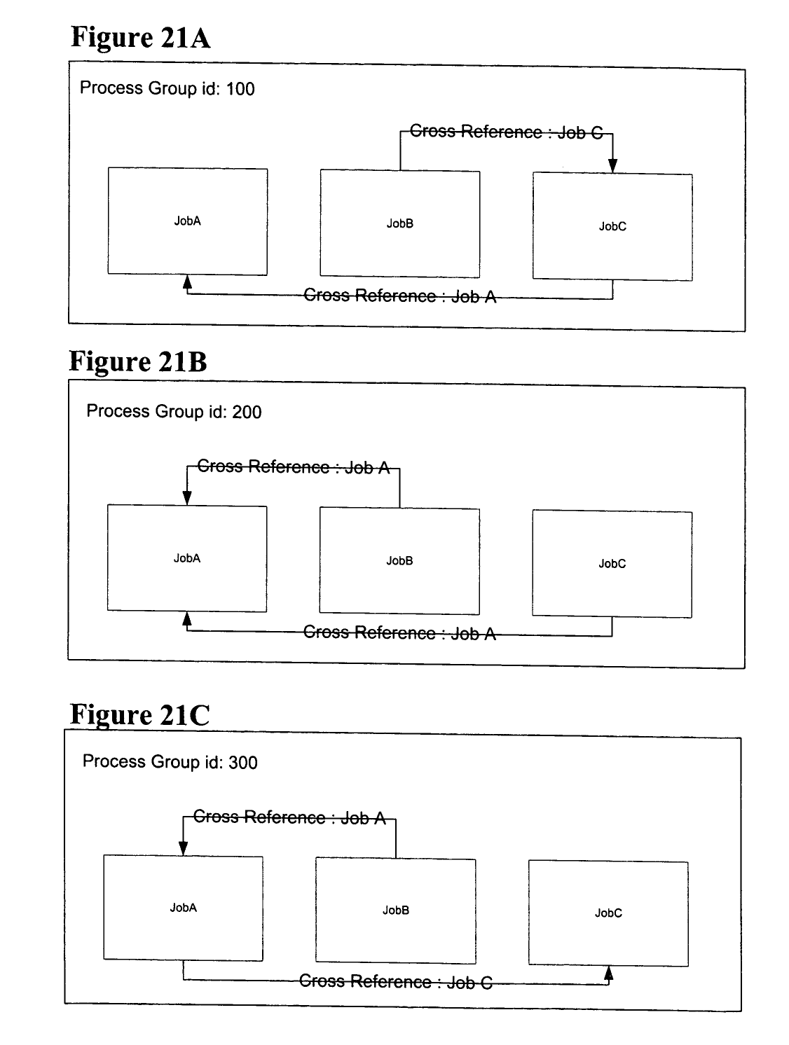

FIGS. 21A to 21C illustrate how dependencies can be defined within process groups. In FIG. 21A, JobB depends upon the state of JobC, and JobC depends upon the state of JobA. In FIG. 21B, both JobB and JobC depend upon the state of JobA. In FIG. 21C, JobB depends upon the state of JobA, and JobA depends upon the state of JobC.

The EDQS event/callback architecture not only eliminates polling and the associated network and supervisor overhead, but also provides superior job dependency tracking, greatly improved implementation of complex job interaction, and ease of adding functionality needed by a given business domain, e.g., email and paging notifications. The EDQS event/callback architecture also enables the use of callbacks for job-specific coordination with third party software, which simplifies meeting unusual requirements imposed by customers served by a farm.

Separate and combined use of EDQS components. Job-driven dispatch and worker-driven dispatch reduce, and sometimes eliminate, the latency between job submission to job start time and significantly reduces the processing power consumed by the supervisory daemon itself. There are only two events that necessarily trigger job dispatch. The first event is submission of a new job; a second event is the availability of a worker to process a job. Both a submission of a job (“new job event”) and completion of a job (“worker report event”) generate a message to the EDQS supervisory daemon. A “new job” message is sent by the job input interface, typically a graphical user interface, upon submission of a job. A “worker report” message is sent by a worker upon completion of a job, addition of a worker to a farm, the return of a worker to service, when a worker fails (e.g., fails to send a heartbeat packet to the supervisor) or is taken off-line by the supervisory daemon, or when the supervisory daemon changes the network identity of a worker (i.e., when an idle worker is re-aliased as a different worker, which is equivalent adding a new worker to a farm). Whether a farm is starting operations for the first time, or has ongoing operations with some or all workers engaged, only these two events, job-driven or worker-driven, respectively, require running the dispatch routine.

The preferred embodiment of the EDQS invention uses EDQS job routing, event-driven CSPS dispatch, the EDQS job type data architecture, the EDQS messaging architecture, EDQS DSL, and the EDQS event/callback architecture with process groups. However, alternative embodiments can omit one or more of these components. For instance, event-driven dispatch can be used as a stand-alone component in a queuing system. Event-driven dispatch requires a system of events, triggers, and callbacks specific to job submissions and processing host availability, and can use a variety of methods for searching and/or sorting jobs and/or hosts, but does not require EDQS job type data architecture, EDQS messaging architecture, EDQS DSL, or the full set of EDQS messages (only the messages equivalent to those used through dispatch of a job, and not later messages, e.g., tracking and status messages). Possible embodiments include those with job-driven dispatch, but not host-driven dispatch, those with host-driven dispatch but not job-driven dispatch, and those with both job-driven and host-driven dispatch.

The EDQS event/callback architecture can be used as a standalone component in a queuing system. The EDQS event/callback architecture requires a system of events, triggers, and callbacks, but does not require a given type of searching, sorting, or dispatch routine, EDQS job routing, EDQS job type data architecture, the EDQS messaging architecture, EDQS DSL, or EDQS messages.

The EDQS messaging architecture can be used as a standalone component in a queuing system. The EDQS messaging architecture requires the messages described in FIG. 11, or substantial equivalents of them, but does not require a given type of searching, sorting, or dispatch routine, EDQS job routing, EDQS event/callback architecture, EDQS job type data architecture, the EDQS messaging architecture, or EDQS DSL.

EDQS DSL can be used as a standalone component in a queuing system. EDQS DSL requires the semantics, syntax, and arguments described above for EDQS DSL, or substantial equivalents of them, but does not require a given type of searching, sorting, or dispatch routine, EDQS job routing, EDQS event/callback architecture, EDQS job type data architecture, or the EDQS messaging architecture.

EDQS job type data architecture can be used as a standalone component in a queuing system, for instance using job type directories and/or job type elements containing a descriptor datum, an executor datum, a GUI name datum, and icon datum, a commander datum, binding scripts, names of associated libraries, and name of index file. Using such job type elements, especially together with job type directories, greatly reduces maintenance (e.g., distribution of maintenance releases and bug fixes) overhead in distributed production facilities.

Those skilled in the art also will readily appreciate that many modifications to the invention are possible within the scope of the invention. Accordingly, the scope of the invention is not intended to be limited to the preferred embodiments described above, but only by the appended claims.

1. A method of job dispatch in a queuing system, comprising:
Aliasing each worker in a plurality of workers to a same or different node in a tree hierarchy;
When a job is submitted for processing, filtering the workers to produce an unsorted, eligible worker list;
Searching the eligible worker list to match a job with a worker by comparing a node weight, and optionally priority, of the job with the nodes;
Selecting a node for the job based optimal comparison;
Reserving a worker aliased to the selected node; and
Dispatching the job to the reserved worker.

2. The method of claim 1, wherein if the reserved worker fails to process the job, the worker is removed from the eligible worker list, and another iteration of the method of claim 1 proceeds, starting from the third step of claim 1.

3. The method of claim 2, wherein each worker reserved in successive iterations of claim 2 fails to process the job, and the number of failures cumulates to a system-defined limit, then the eligible worker list is sorted, and the job is dispatched to the first ranked worker on the sorted worker list.

4. The method of claim 1, wherein a check environment process associated with the job executes on the reserved worker after the step of dispatching the job to the reserved worker, which process compares job attributes with worker attributes, and if the job attributes do not acceptably match the worker attributes, the worker rejects the job, the worker is removed from the eligible worker list, and another iteration of the method of claim 1 proceeds from the third step of claim 1.

5. The method of claim 4, wherein each worker reserved in successive iterations of claim 3 rejects the job, and the number of rejections cumulates to a system-defined limit, then the eligible worker list is sorted, and the job is dispatched to the first ranked worker on the sorted worker list.

6. A method of job dispatch in a queuing system, comprising:
Aliasing each worker in a plurality of workers to a same or different node in a tree hierarchy;
When a worker becomes available for processing a job, filtering jobs to produce an unsorted, eligible job list;
Searching the eligible job list to match a job with a worker by comparing a node weight, and optionally priority, of the job with the node to which the worker is aliased;
Selecting a job for the worker's node based optimal comparison;
Reserving the worker; and
Dispatching the job to the reserved worker.

7. The method of claim 6, wherein if the reserved worker fails to process the job, the job is removed from the eligible job list, and another iteration of the method of claim 6 proceeds, starting from the third step of claim 6.

8. The method of claim 7, wherein each job dispatched to the worker in successive iterations of claim 7 results in the worker's failure to process the job, and the number of failures cumulates to a system-defined limit, then the eligible worker job is sorted, and the first ranked job on the sorted job list is dispatched to the worker.

9. The method of claim 6, wherein a check environment process associated with the job executes on the reserved worker after the step of dispatching the job to the reserved worker, which process compares job attributes with worker attributes, and if the job attributes do not acceptably match the worker attributes, the worker rejects the job, the job is removed from the eligible job list, and another iteration of the method of claim 6 proceeds from the third step of claim 6.

10. The method of claim 9, wherein each job dispatched in successive iterations of claim 9 results in the worker's rejection of the job, and the number of rejections cumulates to a system-defined limit, then the job list is sorted, and the first ranked job on the sorted job list is dispatched to the worker.

11. A queuing system comprising at least one client, at least one supervisor, and at least one worker, together with network communications between each client and supervisor and between each supervisor and worker, and a component selected from the group comprising EDQS messaging architecture, EDQS event-driven dispatch, EDQS event/callback architecture, EDQS job type data architecture, and the EDQS domain specific language.

12. The queuing system of claim 11, wherein the job type data architecture comprises a job type element containing a descriptor datum, an executor datum, a GUI name datum, and icon datum, a commander datum, binding scripts, names of associated libraries, and name of index file.

13. The job type data architecture of claim 12, further comprising a job type directory that contains the job type element, together with code files identified in the job type element.

14. The queuing system of claim 11, wherein the messaging architecture uses messages written in the EDQS domain specific language.

15. The queuing system of claim 11, wherein the domain specific language uses a message generator that converts platform-specific commands into a data structure that can be interpreted by other types of platforms.

16. The queuing system of claim 11, wherein the event/callback architecture is based on enabling triggers whenever predefined Boolean expressions of event states are true, which enabled triggers cause callback code to be executed by a supervisor.

17. The event/callback architecture of claim 16, wherein the callback code causes a job-driven dispatch.

18. The event/callback architecture of claim 16, wherein the callback code causes a worker-driven dispatch.

19. The event/callback architecture of claim 16, wherein the trigger evaluates Boolean expressions of event states of one or more jobs in a process group.

20. The event/callback architecture of claim 16, wherein the event/callback architecture uses evname, evtype, and evcontext variables to define an event.
